(19) United States
(12) Patent Application Publication
(10) Pub. No.: US 2026/0203604 A1
(43) Pub. Date: Jul. 16, 2026

(54) ASYNCHRONOUS SERVING ARCHITECTURE FOR CUSTOMIZED CONTENT ITEMS

(71) Applicant: Microsoft Technology Licensing, LLC, Redmond, WA (US)

(72) Inventors: Haichao Wei, Santa Clara, CA (US); Avi Romascanu, Redmond, WA (US); Hao Tong, Great Neck, NY (US); George Jefferson Lok, San Jose, CA (US); Renpeng Fang, Mountain View, CA (US)

(73) Assignee: Microsoft Technology Licensing, LLC, Redmond, WA (US)

(21) Appl. No.: 19/022,194

(22) Filed: Jan. 15, 2025

(51) Int. Cl. G06N 5/022

(52) U.S. Cl. CPC G06N 5/022

(57) ABSTRACT

Custom content generation techniques for connection networking are described. A method comprises receiving a first signal indicating an entity session associated with an entity identifier, retrieving a first content item associated with the entity identifier from a memory cache, presenting the first content item in a first content slot of a first section of a graphical user interface (GUI) in response to the first signal, wherein the first section is in a rendered section of the GUI, generating a second content item associated with the entity identifier using a generative artificial intelligence model in response to the first signal, determining whether the second content item is received, and assigning the second content item to a second content slot of a second section of the GUI when the second content item is received, wherein the second section is in a non-rendered section of the GUI.

### BACKGROUND

Software applications harness the power of computer networks to distribute a wide variety of digital content to user computing devices. To assess the effectiveness of these content distribution systems, developers rely on “signals” generated at the recipient devices. These signals comprise measurable user interactions, including clicks, conversions, session durations, and a range of other user interface events. By analyzing these interactions, the reach and impact of a particular content delivery mechanism or ranking algorithm can be determined. The signals reveal whether the right audience is being targeted and engaged, and to what extent they respond to the distributed content. This feedback loop not only helps quantify performance but also guides the iterative refinement of ranking models, content personalization strategies, and overall user experience. Over time, the insights gleaned from these signals become invaluable for optimizing content distribution campaigns, ensuring that they are more closely aligned with evolving user preferences and behaviors.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a connection network system in accordance with one embodiment.

FIG. 2 illustrates a system in accordance with one embodiment.

FIG. 3 illustrates a content delivery system in accordance with one embodiment.

FIG. 4 illustrates graphical user interface (GUI) view in accordance with one embodiment.

FIG. 5 illustrates a logic diagram in accordance with one embodiment.

FIG. 6 illustrates a logic diagram in accordance with one embodiment.

FIG. 7 illustrates a logic diagram in accordance with one embodiment.

FIG. 8 illustrates a logic diagram in accordance with one embodiment.

FIG. 9 illustrates a machine learning (ML) architecture in accordance with one embodiment.

FIG. 10 illustrates a transformer model in accordance with one embodiment.

FIG. 11 illustrates a logic flow in accordance with one embodiment.

FIG. 12 illustrates a logic flow in accordance with one embodiment.

FIG. 13 illustrates an apparatus in accordance with one embodiment.

FIG. 14 illustrates a logic diagram in accordance with one embodiment.

FIG. 15 illustrates an artificial neural network (ANN) in accordance with one embodiment.

FIG. 16 illustrates a computer-readable storage medium in accordance with one embodiment.

FIG. 17 illustrates a computing architecture in accordance with one embodiment.

FIG. 18 illustrates a communications architecture in accordance with one embodiment.

### DETAILED DESCRIPTION

Embodiments are generally directed to a connection network system. Some embodiments are particularly directed to artificial intelligence (AI) and machine learning (ML) techniques to support applications and/or services provided by a connection network system. For example, embodiments of the present disclosure introduce a dynamic, real-time adaptable ranking mechanism for systems that organize and deliver lists of content items to user devices. In some embodiments, a content item in a list of content items comprises a personalized content item generated for an entity (e.g., a user) using AI/ML techniques. The content items are displayed within ordered sets of user interface “content slots” (or slots) which can assume various configurations. A common example is a graphical user interface (GUI) content feed, such as a news feed or professional media timeline, where content slots are arranged sequentially and scrolled either horizontally or vertically. However, many other spatial arrangements fit this concept, including grids, horizontally aligned notifications, and vertical pop-ups. In each case, content items occupy specific slots that are updated in real time based on the adaptive ranking system. Specific slots may be in a rendered area of the GUI for presentation to a user on an electronic display, while other slots may be in a non-rendered area (or pre-rendered) of the GUI that is ready for presentation to a user. This approach ensures users receive relevant information dynamically while scrolling, with the flexibility to adjust slot allocation and ordering according to evolving usage patterns and contextual factors. Although exemplary embodiments are described in connection with a particular AI system or an ML model, the principles described herein can also be applied to other types of AI systems and ML models as well. Embodiments are not limited in this context.

### Overview

A connection network system is an online platform for professionals that fosters business connections, supports career advancement, and facilitates industry-specific collaborations. A connection network system is a membership-based service that caters to professionals, job seekers, recruiters, and companies of all sizes. Users can create in-depth profiles highlighting their work experience, education, skills, endorsements, and achievements, enabling them to network strategically, join interest-based groups, and stay informed on industry trends. In addition to its powerful networking capabilities, a connection network system integrates features that assist with job discovery, enabling individuals to receive personalized job recommendations, apply directly through the platform, and engage with potential employers. Companies leverage network services for talent acquisition, employer branding, company updates, and thought leadership activities, making it a central hub for building a professional presence. Furthermore, a connection network system offers an extensive catalog of courses to help users develop new skills, enhance their resumes, and reach their career goals, while the platform's publishing tools allow members to share original articles, insights, and multimedia content that can increase visibility and credibility. Together, these robust features create an indispensable resource for professionals seeking meaningful connections, professional growth, and valuable business opportunities across a wide array of industries.

A connection network system may provide access to a large amount of electronic content aimed at professional networking and career development. For example, a connection network system may list employment opportunities posted by employers across different industries, professional profiles with detailed information about entities of the connection network system (e.g., work experience, skills, and endorsements), articles or posts created by entities and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where entities can share ideas and discuss industry trends, and other types of content designed to facilitate professional growth and industry engagement.

Various types of entities may generate, modify, store, read, or otherwise interact with the electronic content of the connection network system. Non-limiting examples of an entities include an individual, a person, an entity, a member, a subscriber, a corporate entity, a company, a business, an organization, a governmental agency, a community, a group, and the like. In some cases, the connection network system collects a variety of data associated with the various types of entities of the platform in accordance with privacy policies which govern how this information is collected, used, and shared. For an entity such as an entity, the entity data may include basic profile information such as name, job title, industry, location, educational background, demographic information, work history, and so forth. For an entity such as a company, the entity data may also include basic profile information such as a company name, description, industry, business segment, jobs, careers, offices, geographic locations, and so forth. Additionally, the connection network system may collect activity data for entities representing various interactions and behaviors exhibited while on the platform. Examples of activity data including interactions between entities or interacting with electronic content of the connection network system, including profile updates, content engagement, search and navigation behavior, job activities, networking activities, group participation, skill endorsements and recommendations, advertisement engagement, learning activities, event participation, followers activities, interactions with external content, engagement patterns, behavioral trends, organic contents, sponsored contents, sales activities, marketing activities, and so forth.

In some cases, a connection network system may enhance network services offered by the connection network system based on the entity data and activity data of its entities. Examples of network services include messaging services, search services, ranking services, recommendation services, advertising services, content delivery services, and so forth. For example, a connection network system may use activity data to personalize entity experiences, optimize content displayed in content feeds, improve targeted advertising, and enhance platform features. It also plays a role in developing analytics and reporting tools, helping entities and businesses understand their network reach, content effectiveness, and engagement with their audience.

A connection network system may offer a content delivery system that delivers electronic content items to various entities based on a number of different factors. For example, the content delivery system may interleave different types of content items for presentation in a content feed of an entity. The content feed is a prominent content area on a webpage (e.g., a homepage) of a website where an entity may view a personalized stream of posts, updates, articles, and activities. It compiles content from network connections, companies followed, and topics of interest to keep informed about professional news, industry trends, job opportunities, and other relevant information for career development. An entity may interact with the content items presented in the content feed by liking, commenting on, and sharing posts, as well as following hashtags to tailor the content to specific interests. The content feed serves as a central hub for networking, learning, and staying updated within a professional community, all personalized through algorithms based on connections and engagement history.

The content feed may comprise a portion of a web section that displays a mixture of different types of content items, such as organic items generally referred to as organic content (OC) and sponsored items generally referred to as sponsored content (SC), for example. OC refers to digital content items that entities share with each other in a connection network system without payment. Non-limiting examples of OC include articles, shares, likes, and so forth. SC refers to digital content items that entities share in a connection network system with payment. Non-limiting examples of SC include digital advertisements, marketing collateral, and so forth. A digital content item may comprise multimedia information of different modalities, such as text, video, graphics, images, audio, animations, or any combination of the foregoing.

A content delivery system uses a blending algorithm that assigns, allocates, or loads OC and SC to content slots in the content feed. A content slot (or simply a slot) is a section of the content feed of some defined dimension and geometry designed to display a given content item to the entity. The section (or section) may be rendered (e.g., rendered) to an entity or non-rendered (pre-rendered) to the entity. The content delivery system may select the different types of content items for different slots of the content feed based on a combination of the entity data, activity data, and/or objectives associated with the entity in order to personalize the content feed. For example, the blending algorithm may select an OC for a first slot of the content feed to increase an engagement metric for the entity, such as a number of likes, comments, or shares. The blending algorithm may select a SC for a second slot of the content feed to increase a revenue metric for the entity. As the entity scrolls through the content feed the blending algorithm assigns more content items to more slots in a seamless and continuous manner. During this process, the blending algorithm attempts to blend the OC and SC in the content feed to achieve one or more defined objectives. The result of this process is a content feed that interleaves the OC and SC in a continuous manner while optimizing for multiple objectives.

Timing for the content feed remains a challenging technical problem. When an entity, such as a user, navigates to the web section to start a browsing session, the content delivery system detects the start of the session and begins generation of the content feed. The content delivery system uses entity data and activity data associated with the user to select OC and SC relevant to the user, and the blending algorithm assigns the OC and SC to content slots in the content feed. Meanwhile, the user interacts with a graphical user interface (GUI) element to scroll through the content feed (either up or down) to read the content items. Consequently, the content delivery system must continuously assign OC and SC to content slots at a delivery rate that is faster than a navigation rate of the user, otherwise the user may view an empty content slot in the content feed of the GUI. This decreases revenue, interrupts interaction between content items and users, and degrades overall user experience.

Embodiments solve these and other technical challenges. A content delivery system uses an asynchronous content switching (ACS) algorithm to allocate digital content items to content slots of a content feed in a seamless and continuous manner. When an entity accesses a UI of a website or application for a session, the content generation system retrieves entity data (e.g., profile information) and entity activity data (e.g., clicks, impressions, subscriptions) to retrieve context information for the entity. The ACS algorithm uses entity data and entity activity data associated with an entity (e.g., a user) to select OC and SC relevant to the entity. The ACS algorithm interoperates with a blending algorithm that assigns the OC and SC to content slots in the content feed. Meanwhile, the entity interacts with a GUI element (e.g., a scroll bar, a button, a drag point, etc.) to scroll through the content feed (either up or down) to read the content items. The ACS algorithm receives this interaction as a position context signal (or timing signal), and it analyzes the position context signal to estimate a position and/or movement of the GUI element. For example, the position context signal may comprise a vector that is a quantity that describes both a direction of movement and a magnitude of movement (e.g., speed) of the GUI element. The ACS algorithm analyzes the position context signal to determine whether the GUI element is moving towards a rendered section or a non-rendered section of the GUI, or vice-versa, and timing associated with such movement. The ACS algorithm uses the position context signal to continuously assign OC and SC to content slots in both the rendered section and non-rendered section at a delivery rate that is faster than a navigation rate of the user while reducing or eliminating the possibility of the user viewing an empty content slot in the content feed of the GUI. This results in an increase in revenue, promotes interaction between content items and users, and enhances overall user experience.

In some embodiments, the content delivery system also uses the ACS algorithm to parallelize generation of custom digital content items for an entity for allocation to content slots of the content feed in a seamless and continuous manner. The ACS algorithm controls timing operations associated with generation and allocation of a custom digital content item for an entity. A generative AI (GAI) model receives entity data and entity activity data for an entity, and it generates a digital content item personalized for the entity. The ACS algorithm manages timing for generation and allocation of the custom content item to accommodate the additional latency introduced by the GAI model using the position context signal. For example, the GAI model may generate multimedia information for a custom digital content item for a given entity on the order of seconds (e.g., 1 second for text information, 2 seconds for images, 3 seconds for animations, etc.). However, the blending algorithm that assigns content items to content slots for a content feed normally operates in split-second intervals (e.g., 0.1 second, 0.3 second, 0.5 second, etc.). Therefore, a technical problem occurs when timing generation of a custom digital content item and assignment of the custom digital content item to a content slot, thereby increasing a probability that an entity may scroll through the content feed and view an empty content slot during a session.

To solve this technical problem, embodiments implement a technical solution using the ACS algorithm. When an entity, such as a user, navigates to the web section to start a browsing session, the content delivery system detects the start of the session and begins generation of the content feed. The blending algorithm receives a signal representing the start of the browsing session, and it starts assigning the OC and SC to content slots in the content feed in response to the signal. The OC and the SC may be pre-generated content items stored in a database and indexed for fast retrieval. Additionally, or alternatively, the content delivery system feeds campaign information, the entity data, and entity activity data to a GAI model along with an input prompt to the GAI model. In some cases, a prompt template may be used. The GAI model begins generation of a custom digital content item for the user for display on the GUI. The ACS algorithm receives a position context signal from the GUI representing movement information of a GUI element of the GUI. The movement information may comprise spatial information, such as a direction of movement of a GUI element of the GUI as the entity navigates the content feed (e.g., scrolling, cursor movement, etc.). The movement information may also comprise temporal information, such as a rate of movement of the GUI element. The ACS algorithm analyzes the movement information, and it estimates a direction of movement and a rate of movement.

The ACS algorithm uses this movement information to identify a time value representing when a non-rendered section of the GUI will be displayed on the GUI view in the future. The ACS algorithm also estimates a time value representing when a custom digital content item generated by the GAI model will be finished and ready to serve in the content feed. The ACS algorithm uses the time values to determine whether it has sufficient time to allocate the custom digital content item in a non-rendered section of the UI before the assigned content item appears in a rendered section of the GUI once the user navigates to the rendered section. If the time values indicate that there is sufficient time remaining to finish generation of the custom digital content item before the user navigates to the rendered section, the ACS algorithm waits for the GAI to finish generating the custom digital content item and when it is ready assigns it to a content slot in the non-rendered section. However, if the time values indicate that there is insufficient time to finish generation of the custom digital content item before the user navigates to the rendered section, the ACS algorithm retrieves and assigns a different content item that is ready to serve, such as pre-generated OC or SU stored in a data store or memory cache. In this manner, the ACS algorithm asynchronously switches different content items into different content slots of the non-rendered section of the content feed to optimize delivery of custom digital content items while ensuring the rendered section of the content feed does not contain any empty content slots.

The ACS algorithm also offers a cross-session feature to show custom content items (e.g., pre-generated custom content items) generated during one session (e.g., a previous session for an entity) in another session (e.g., a subsequent session for the entity). Using the movement information in combination with entity data, entity activity data, and SC campaign data solves the latency problem of the GAI model by using the time for movement to compensate for the high latency of GAI generation. It also positions the custom digital content item in a non-rendered section of the GUI while having a high-probability of viewing by the user. This optimizes technical resources in generating and placing customized content items in a GUI for users while lowering costs-to-serve.

Embodiments provide several technical solutions to multiple technical problems. For example, latency associated with generating custom digital content items using a GAI model is higher than tolerated by content delivery systems. The GAI model cannot finish generation of the custom digital content item before it needs delivery to a content feed of a GUI. Embodiments leverage asynchronous content switching to parallelize the generation so that the custom digital content item is shown when the user navigates the content feed. For instance, as the user navigates through the content feed, the ACS algorithm allows delivery of the custom digital content item within a session in real-time (e.g., sub-second) or near real-time (e.g., seconds) in order to show the custom digital content item within a single session. With real-time service, when a user is reading section 1 of the content feed, the GAI model is generating the custom digital content item for section 2 of the content feed. It usually takes the user seconds to scroll down from section 1 to section 2. This additional buffer time is used for generating the custom digital content item so that the user can browse the new custom digital content item within the session. In another example, embodiments are capable of generating and assigning custom digital content items across multiple sessions. For example, a content delivery system can index and cache the custom digital content item for a defined period of time (e.g., days, weeks, months, etc.). If the user is an active user that visits the connection network system on a regular basis, the user will view the custom digital content item generated during one session in another session in a prominent manner, such as a first content slot of the content feed of the GUI. In still another example, GAI cost-to-serve is relatively high, such as $0.02 per image. If a custom digital content item is generated but never viewed by the user, this cost is potential wasted. Embodiments use various GAI cost-efficiency optimizations to reduce GAI cost-to-server. In yet another example, conventional systems do not use GAI-related signals into serving logic used to select content items, and therefore select less relevant content items costing both revenue and engagement from the user. Embodiments use GAI-related signals to select more relevant content items to increase both revenue and engagement of the user. Other technical advantages exist as well.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### Detailed Embodiments

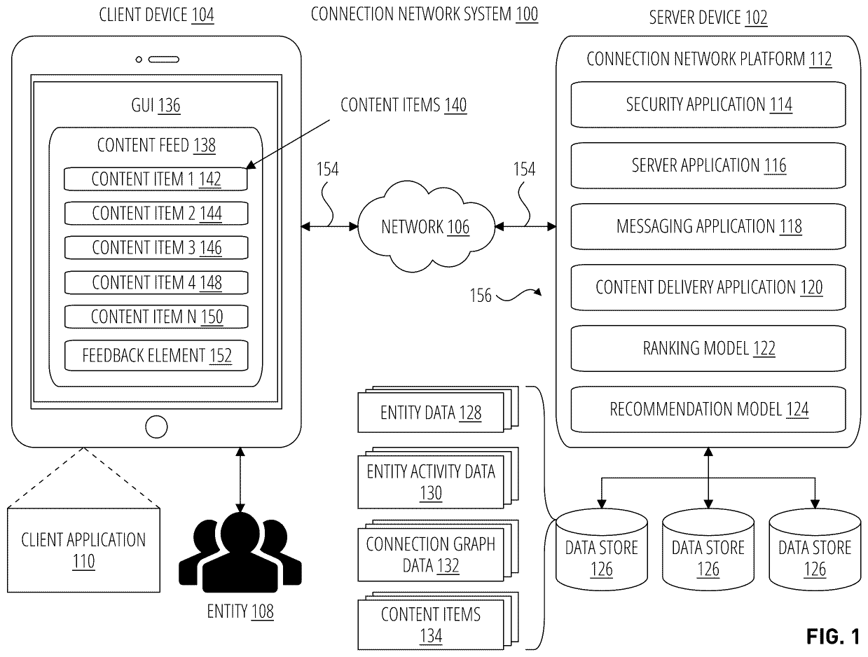

FIG. 1 illustrates a connection network system 100. The connection network system 100 is an example of an architecture or framework for an online computer and communications system designed to serve content items to an electronic device associated with a user. Embodiments are not limited to this example.

In general, the connection network system 100 may include a variety of servers, sub-systems, programs, modules, logs, and data stores. In particular embodiments, the connection network system 100 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The connection network system 100 may also include suitable components such as network interfaces, security mechanisms, load balancers, failover servers, management-and-network-operations consoles, privacy software, and other suitable components, or any suitable combination thereof.

As depicted in FIG. 1, the connection network system 100 comprises a server device 102 communicating with a client device 104 over a network 106. Additionally, or alternatively, the client device 104 may communicate with another client device 104 in a peer-to-peer (P2P) mode or via the server device 102. In operation, an entity 108 interacts with a client application 110 of the client device 104 to access applications and services provided by a connection network platform 112 of the server device 102. The connection network platform 112 offers a number of network services 156 for the connection network system 100, such as network services provided by a security application 114, a server application 116, a messaging application 118, a content delivery application 120, a ranking model 122, and/or a recommendation model 124. The server device 102 has access to one or more data stores 126. The data stores 126 store information for the connection network platform 112, such as entity data 128, entity activity data 130, connection graph data 132, and content items 134.

The connection network system 100 comprises a server device 102. In particular embodiments, a server device 102 may be an electronic device including hardware, software, or embedded logic components or a combination of two or more such components and capable of carrying out the appropriate functionalities implemented or supported by a server device 102. The server device 102 may comprise a unitary server or a distributed server spanning multiple computers or multiple data centers. The server device 102 may comprise one or more physical servers or virtual servers hosting one or more networking applications. As an example and not by way of limitation, a server device 102 may comprise part of a larger server system comprising multiple server devices organized as a data center, an edge computing center, or a cloud-computing center. This disclosure contemplates any suitable server device 102. A server device 102 may be accessed by a network entity 108 at a client device 104 via the network 106. A client device 104 may enable its entity 108 to communicate with other entities 108 at the server device 102, such as via messaging applications 118.

In one embodiment, for example, the server device 102 may be implemented as a web server. The web server may be used for linking the connection network platform 112 to one or more of the client devices 104 via a network 106. The web server may include a mail server or other messaging functionality for receiving and routing messages between the connection network platform 112 and one or more client devices 104. An API-request server may allow a gaming platform, a third-party system, a messaging system, and/or an AI system to access information from the connection network platform 112 by calling one or more APIs. An action logger may be used to receive communications from a web server about a user's actions on or off the connection network platform 112. In conjunction with the action log, a third-party-content-object log may be maintained of user exposures to third-party-content objects. A notification controller may provide information regarding content objects to a client device 104. Information may be pushed to a client device 104 as notifications, or information may be pulled from a client device 104 responsive to a request received from a client device 104. Authorization servers may be used to enforce one or more privacy settings of the users of the connections networking system. A privacy setting of a user determines how particular information associated with a user can be shared. The authorization server may allow users to opt in to or opt out of having their actions logged by the connection network platform 112 or shared with other systems (e.g., a third-party system), such as, for example, by setting appropriate privacy settings. Third-party-content-object stores may be used to store content objects received from third parties, such as a third-party system. Location stores may be used for storing location information received from client device 104 associated with users. Advertisement-pricing modules may combine connections information, the current time, location information, or other suitable information to provide relevant advertisements, in the form of notifications, to a user.

The connection network system 100 comprises a connection network platform 112. In particular embodiments, the connection network platform 112 may be part of a network-addressable computing system that can host an online connection network. The connection network platform 112 may generate, store, receive, and send connection networking data, such as, for example, entity data 128 (e.g., user-profile data, concept-profile data, etc.), entity activity data 130 (e.g., user interactions with connection network platform 112), connection graph data 132 (e.g., connections between users or entities), content items 134, or other suitable data related to the online connection network. The connection network platform 112 may be accessed by the other components of the connection network system 100 either directly or via a network 106. As an example and not by way of limitation, a client device 104 may access the connection network platform 112 using the client application 110, which may be a web browser or a native application associated with the connection network platform 112 (e.g., a mobile connection network application, another suitable application, or any combination thereof) either directly or via a network 106.

The connection network platform 112 comprises a security application 114. In particular embodiments, a security application 114 may be an application or electronic device including hardware, software, or embedded logic components or a combination of two or more such components and capable of carrying out the appropriate functionalities implemented or supported by the security application 114. The security application 114 is a network security system that encompasses a suite of technologies, policies, and practices designed to protect the integrity, confidentiality, and availability of data within the connection network platform 112 from unauthorized access, attacks, and other security threats. The security application 114 comprises components such as firewalls, which act as a barrier between trusted and untrusted networks; Intrusion Detection and Prevention Systems (IDPS) that monitor for malicious activity; antivirus and anti-malware software for removing harmful software; and Virtual Private Networks (VPNs) for secure remote access. Additionally, Data Loss Prevention (DLP), email security measures, and encryption are vital for protecting sensitive information and ensuring that only authorized users can access and understand it. Effective network security also requires rigorous access control to restrict network resources to authorized users, alongside Security Information and Event Management (SIEM) systems for real-time security alert analysis. Endpoint security further safeguards devices connected to the network, which are frequent entry points for security threats. The security application 114 implements security practices to ensure a robust defense against a wide array of cyber threats, safeguarding organizational assets and maintaining trust with stakeholders.

The connection network platform 112 comprises a server application 116. In particular embodiments, the server application 116 may be a web server to serve content information, such as content items 134, to the client application 110 of the client device 104. The server device 102 may accept an HTTP request and communicate to a client device 104 one or more HTML files responsive to the HTTP request. The server device 102 may send HTML files representing a webpage with content information for presentation via an electronic display of the client device 104 to the entity 108.

In particular embodiments, the server application 116 may be an application operable to provide various computing functionalities, services, and/or resources, and to send data to and receive data from the other entities of the network 106, such as the client device 104, the connection network platform 112, a third-party server, and other electronic devices within the connection network system 100. For example, the server application 116 may be an e-commerce application, a content application, an advertisement application, a web interface, a messaging application, a video application, a webpage, and so forth.

In particular embodiments, the server application 116 may be an application for managing various applications and services provided by the online connection network hosted on the connection network platform 112. In particular embodiments, the server application 116 may include hardware, software, or embedded logic components or a combination of two or more such components for carrying out the appropriate functionalities implemented or supported by connection network platform 112. Although the server device 102 is shown with a single server application 116, it should be noted that this is not by any way limiting and this disclosure contemplates any number of server applications 116.

The connection network platform 112 comprises a messaging application 118. The messaging application 118 is software that enables users to send and receive messages, including text, images, videos, and other multimedia content, over a network 106, such as a local or broad network such as the internet. These applications support real-time communication, allowing immediate message exchange, and typically offer features like group messaging, notifications, and file sharing. They manage user identities, contacts, and groups, while ensuring security through authentication and encryption measures. Designed to operate over various network types, such as Wi-Fi or cellular data, messaging applications can also integrate with other network services and platforms, enhancing their functionality and user experience.

The connection network platform 112 comprises a content delivery application 120. The content delivery application 120 is a software tool that allows users to efficiently deliver content items to other users of the connection network platform 112 of the connection network system 100, such as content items 134 stored by one or more data stores 126 or third-party content servers. An example for the content delivery application 120 is a demand-side platform (DSP) used by users such as employees (e.g., an account manager) for an advertising entity. A DSP allows advertisers to purchase and manage ad inventory from multiple ad exchanges and networks through a single interface to implement marketing solutions for products or services of the advertiser. The content delivery application 120 allows advertisers to create, manage, and analyze their ad campaigns on the platform in accordance with a larger programmatic advertising strategy. It allows for precise targeting based on entity data 128 and/or entity activity data 130, making it especially useful for business-to-business (B2B) or business-to-consumer (B2C) marketing campaigns. The content delivery application 120 delivers content items 134, such as a series of one or more advertisements, to an audience of entities 108 of the connection network platform 112 of the connection network system 100. The content delivery application 120 assist advertisers in delivering content and ads to a professional audience by leveraging user profiles, job titles, industries, and other entity data 128 and entity activity data 130 collected by the connection network platform 112.

The connection network platform 112 comprises various machine learning (ML) models, such as a ranking model 122. A ranking model 122 in machine learning is a ML model designed to order or prioritize a set of items based on their relevance to a given query. Unlike traditional classification or regression models, ranking models output a sorted list of items, making them essential for applications like information retrieval systems, recommendation engines, and search engines. They predict the relevance of each item, employing specialized loss functions and feature engineering to optimize ranking order. Performance is evaluated using metrics such as Mean Reciprocal Rank (MRR) and Normalized Discounted Cumulative Gain (NDCG). Examples include RankNet, LambdaRank, and LambdaMART, which are used by the connection network platform 112 to surface the most relevant results or recommendations to users.

The connection network platform 112 comprises various ML models, such as a recommendation model 124. A recommendation model 124 in machine learning is an ML model designed to predict and suggest items that are likely to be of interest to users, analyzing patterns in user behavior, preferences, and interactions to generate personalized recommendations. These models are widely used in e-commerce, streaming services, and social media to enhance user experience and engagement. Techniques include collaborative filtering, which identifies similarities between users and items based on interactions and feedback, and content-based filtering, which recommends items similar to those a user has shown interest in based on item attributes. Hybrid methods combine multiple approaches to improve accuracy and diversity. Evaluation metrics for recommendation models include precision, recall, Mean Average Precision (MAP), and Normalized Discounted Cumulative Gain (NDCG). Examples include matrix factorization techniques, deep learning approaches like neural collaborative filtering, and graph-based methods, as utilized by platforms such as YouTube, Spotify, and Amazon to provide tailored content and product suggestions.

The server device 102 comprises, or has access to, one or more data stores 126. In particular embodiments, the connections networking system 102 may include a data store 126. The data store 126 may be used to store various types of information for the server device 102 and/or the connection network platform 112. In particular embodiments, the information stored in the data store 126 may be organized according to specific data structures. In particular embodiments, the data store 126 may be a relational, columnar, correlation, or other suitable database. Although this disclosure describes or illustrates particular types of databases, this disclosure contemplates any suitable types of databases. Particular embodiments may provide interfaces that enable a client device 104 or a connection network system 100 to manage, retrieve, modify, add, or delete, the information stored in the data store 126.

In one embodiment, for example, the data store 126 stores entity data 128 for the connection network platform 112. In particular embodiments, the connection network platform 112 may include entity data 128 for various entities of the connection network platform 112. Non-limiting examples of entities may include users, individuals, members, businesses, companies, organizations, software agents, hardware agents, and so forth. For example, the entity data 128 may comprise one or more user profiles associated with users of the connection network platform 112. A user profile may include, for example, biographic information, demographic information, behavioral information, social information, professional information, or other types of descriptive information, such as work experience, educational history, hobbies or preferences, interests, affinities, or location. Interest information may include interests related to one or more categories. Categories may be general or specific. The connection information may indicate users who have similar or common work experience, group memberships, hobbies, educational history, or are in any way related or share common attributes. The connection information may also include user-defined connections between different users and content (both internal and external).

In one embodiment, for example, the data store 126 stores entity activity data 130 for the connection network platform 112. The entity activity data 130 represents various activities recorded for an entity 108 by the connection network platform 112. In particular embodiments, the connection network platform 112 may provide entities (e.g., users) with the ability to take actions on various types of items or objects supported (or accessible) by connection network platform 112. As an example and not by way of limitation, the items and objects may include groups or connections networks to which users of the connection network platform 112 may belong, events or calendar entries in which a user might be interested, computer-based applications that a user may use, transactions that allow users to apply to job openings or post job openings via the service, interactions with advertisements that a user may perform, content items, online games, or other suitable items or objects. A user may interact with anything that is capable of being represented in the connection network platform 112 or by an external system of a third-party system, which is separate from the server device 102 and coupled to the server device 102 via a network 106.

In one embodiment, for example, the data store 126 stores connection graph data 132 for the connection network platform 112. The connection network platform 112 may store connection graph data 132 for one or more users (e.g., members with subscription accounts) of the connection network platform 112. In one embodiment, for example, connection graph data 132 may be connection data for users organized as a graph. The graph may include multiple nodes, which may include multiple user nodes each corresponding to a particular user or multiple entity nodes each corresponding to a particular entity, such as a business entity. The graph may also have multiple edges connecting the nodes. The connection network platform 112 may provide users of the online connection network system 100 the ability to communicate and interact with other users. In particular embodiments, users may join the online connection network platform 112 via the connection network system 100 and then add connections (e.g., relationships) to a number of other users of the connection network platform 112 to whom they want to be connected. Herein, the term “connection” may refer to any other user of the connection network platform 112 or the connection network system 100 with whom a user has formed a friendship, association, or relationship via the connection network platform 112.

In one embodiment, for example, the data store 126 stores content items 134 for the connection network platform 112. The content items 134 may comprise any type of multimedia content, such as text files, multimedia files, image files, video files, graphic files, movies, articles, user feeds, advertisements for a content delivery campaign, banners, recommendations, games, messages, emojis, program code, animations, and so forth. In particular embodiments, the connection network platform 112 also includes user-generated content (UGC) objects, which may enhance a user's interactions with the connection network platform 112. User-generated content may include anything a user can add, upload, send, message, or “post” to the connection network platform 112. As an example and not by way of limitation, a user communicates posts to the connection network platform 112 from a client device 104. Posts may include data such as status updates or other textual data, articles, job openings, company information, awards, location information, photos, videos, links, music or other similar data or media. Content may also be added to the connection network platform 112 by a third-party through a “communication channel,” such as a newsfeed or content stream.

The connection network system 100 comprises a client device 104. In particular embodiments, a client device 104 may be an electronic device including hardware, software, or embedded logic components or a combination of two or more such components and capable of carrying out the appropriate functionalities implemented or supported by a client device 104. As an example and not by way of limitation, a client device 104 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client device 104. A client device 104 may enable a network user at a client device 104 to access a network 106. A client device 104 may enable its entity 108 to communicate with other entities 108 at other client devices 104, such as via messaging application 118.

The connection network system 100 comprises a client application 110. In particular embodiments, a client device 104 may include a client application 110, which may be a web browser, and may have one or more add-ons, plug-ins, or other extensions. An entity 108 at a client device 104 may enter a Uniform Resource Locator (URL) or other address directing a web browser to a particular server device 102 such as a server or server data center for a connection network platform 112, and the web browser may generate a Hyper Text Transfer Protocol (HTTP) request and communicate the HTTP request to the server device 102. The server device 102 may accept the HTTP request and communicate to a client device 104 one or more Hyper Text Markup Language (HTML) files responsive to the HTTP request. The client device 104 may render a web interface (e.g. a webpage) based on the HTML files from the server for presentation via an electronic display of the client device 104 to the entity 108. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser may use to render the web interface) and vice versa, where appropriate.

In particular embodiments, the client application 110 may be an application operable to provide various computing functionalities, services, and/or resources, and to send data to and receive data from the other entities of the network 106, such as the connection network platform 112. For example, the client application 110 may be a client connection network application tightly integrated with the connection network platform 112, a messaging application 118 for messaging with entities 108 of a messaging network or system, a web browser application, an internet searching application, and so forth.

In particular embodiments, the client application 110 may be storable in a memory and executable by a processor circuitry of the client device 104 to render user interfaces, receive user input, send data to and receive data from the connection network platform 112. The client application 110 may generate and present user interfaces to a user via an electronic display of the client device 104. For example, the client application 110 may generate and present a GUI 136 based at least in part on information received from the server device 102, the connection network platform 112, and/or another device or system (e.g., a third party server) via the network 106.

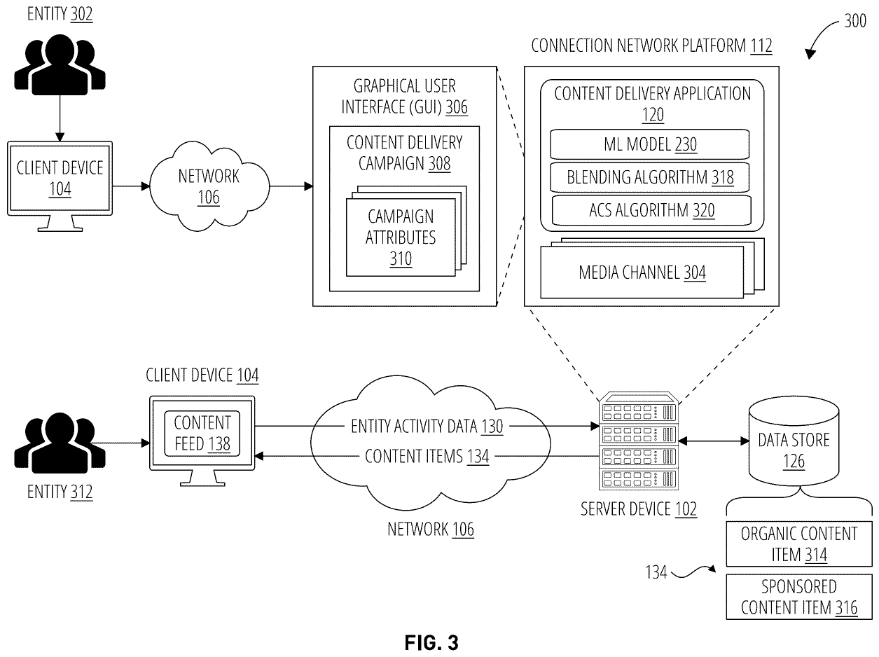

In some embodiments, the connection network platform 112 and/or the client application 110 and/or an operating system of the client device 104 may generate a GUI 136 on an electronic display of the client device 104. The client application 110 may receive one or more content items 134 from the data store 126 of the connection network platform 112 from the content delivery application 120. The client application 110 may display the content items 134 as content items 140 on a content feed 138 of the GUI 136. The content items 140 may include a feedback element 152 that when selected or activated by the entity 108, causes the GUI 136 to generate a signal such as a message for delivery to the content delivery application 120 of the connection network platform 112. The signal or message may comprise a feedback signal to the content delivery application 120 for use by the content delivery application 120 to select a new content item from the data store 126 for delivery to the client device 104. For example, the content delivery application 120 may use the feedback signal as part of an ML model to select content items 134 for a marketing campaign managed by the content delivery application 120, as described in more detail with reference to FIG. 3.

The connection network system 100 comprises a network 106. This disclosure contemplates any suitable network 106. As an example and not by way of limitation, one or more portions of a network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A single network 106 may comprise multiple networks 106.

In operation, an entity 108 interacts with a client application 110 of the client device 104 to access applications and services provided by a connection network platform 112 of the server device 102 via one or more links 154 of the network 106. The links 154 may connect each client device 104 to the connection network platform 112 via the network 106. This disclosure contemplates any suitable link 154. In particular embodiments, one or more links 154 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 154 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 154, or a combination of two or more such links 154. Links 154 need not necessarily operate at the same throughout. One or more first links 154 may differ in one or more respects from one or more second links 154.

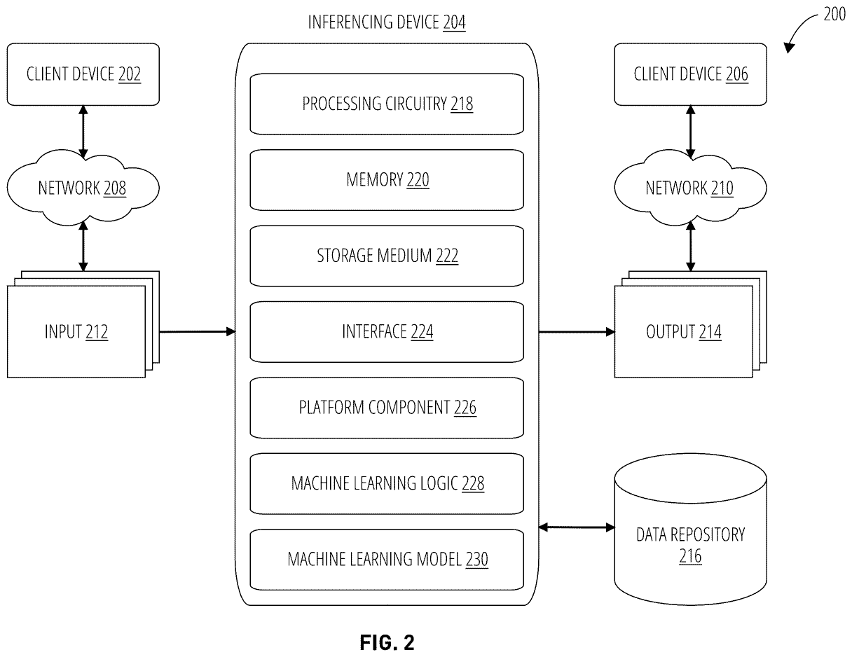

FIG. 2 illustrates an embodiment of a system 200. The system 200 is suitable for implementing one or more embodiments as described herein. In one embodiment, for example, the system 200 is an AI/ML system suitable for implementing models described with reference to any of the preceding description.

The system 200 comprises a set of M devices, where M is any positive integer. FIG. 2 depicts three devices (M=3), including a client device 202, an inferencing device 204, and a client device 206. The inferencing device 204 communicates information with the client device 202 and the client device 206 over a network 208 and a network 210, respectively. The information may include input 212 from the client device 202 and output 214 to the client device 206, or vice-versa. In one alternative, the input 212 and the output 214 are communicated between the same client device 202 or client device 206. In another alternative, the input 212 and the output 214 are stored in a data repository 216. In yet another alternative, the input 212 and the output 214 are communicated via a platform component 226 of the inferencing device 204, such as an input/output (I/O) device (e.g., a touchscreen, a microphone, a speaker, etc.).

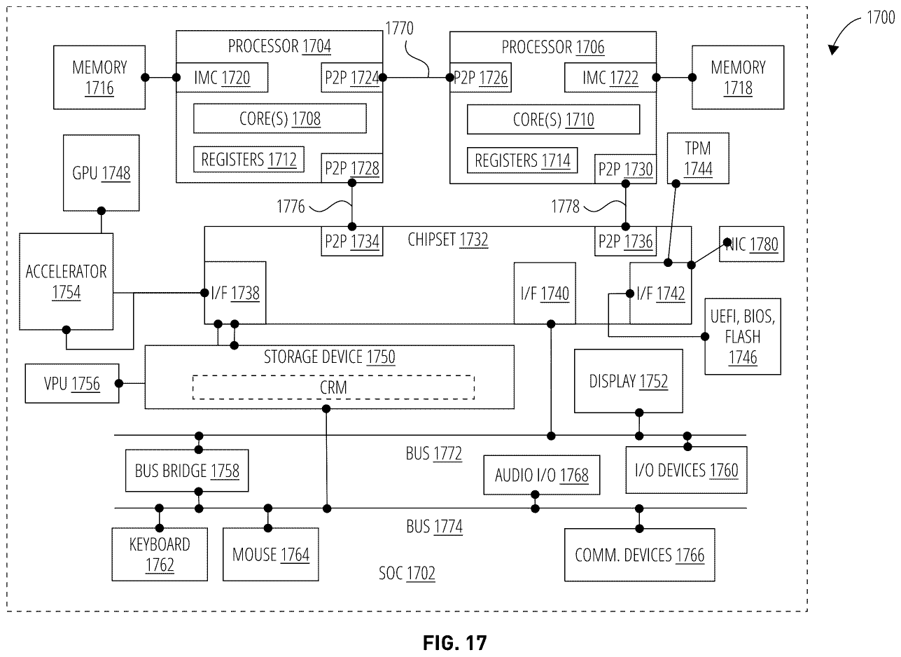

As depicted in FIG. 2, the inferencing device 204 includes processing circuitry 218, a memory 220, a storage medium 222, an interface 224, a platform component 226, ML logic 228, and an ML model 230. In some implementations, the inferencing device 204 includes other components or devices as well. Examples for software elements and hardware elements of the inferencing device 204 are described in more detail with reference to a computing architecture 1700 as depicted in FIG. 17. Embodiments are not limited to these examples.

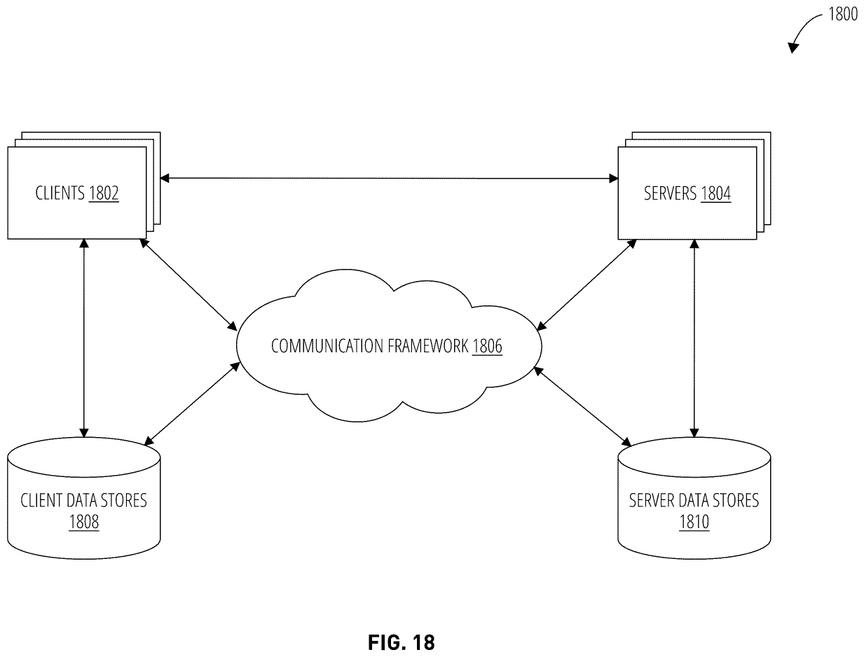

The inferencing device 204 is generally arranged to receive an input 212, process the input 212 via one or more AI/ML techniques, and send an output 214. The inferencing device 204 receives the input 212 from the client device 202 via the network 208, the client device 206 via the network 210, the platform component 226 (e.g., a touchscreen as a text command or microphone as a voice command), the memory 220, the storage medium 222 or the data repository 216. The inferencing device 204 sends the output 214 to the client device 202 via the network 208, the client device 206 via the network 210, the platform component 226 (e.g., a touchscreen to present text, graphic or video information or speaker to reproduce audio information), the memory 220, the storage medium 222 or the data repository 216. Examples for the software elements and hardware elements of the network 208 and the network 210 are described in more detail with reference to a communications architecture 1800 as depicted in FIG. 18. Embodiments are not limited to these examples.

The inferencing device 204 includes ML logic 228 and an ML model 230 to implement various AI/ML techniques for various AI/ML tasks. The ML logic 228 receives the input 212, and processes the input 212 using the ML model 230. The ML model 230 performs inferencing operations to generate an inference for a specific task from the input 212. In some cases, the inference is part of the output 214. The output 214 is used by the client device 202, the inferencing device 204, or the client device 206 to perform subsequent actions in response to the output 214.

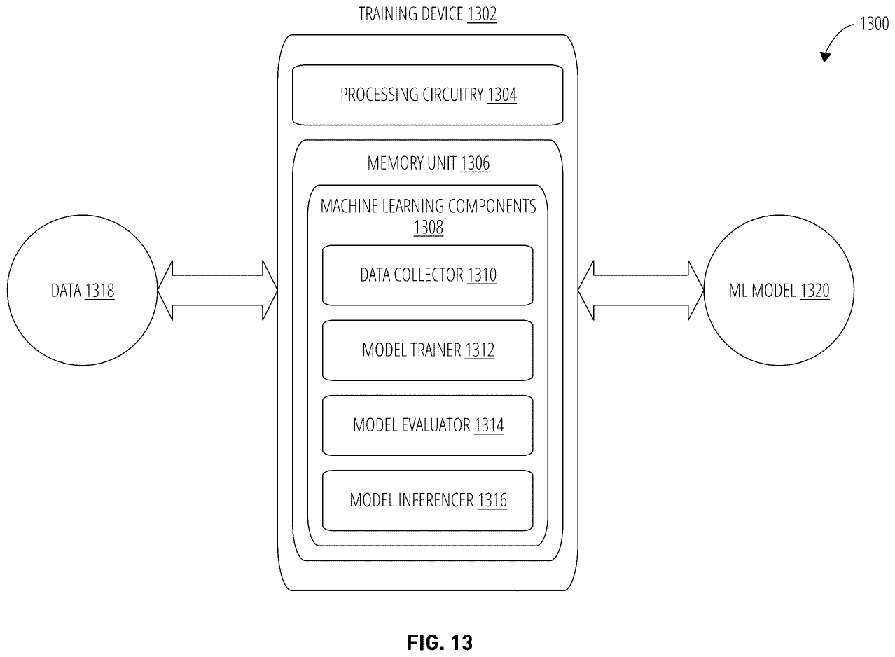

In various embodiments, the ML model 230 is a trained ML model 230 using a set of training operations. An example of training operations to train the ML model 230 is described with reference to FIG. 13.

FIG. 3 illustrates a content delivery system 300. The content delivery system 300 is an example of a system designed to deliver one or more content items 134 such as one or more organic content item 314 and/or sponsored content item 316 to an entity 312 of the connection network platform 112 of the connection network system 100. The content delivery system 300 delivers the content items 134 in a targeted manner. The content items 134 may comprise, for example, recommendations, advertisements, content, messages, suggestions, hyperlinks, files, job postings, articles, and any other content offered by the connection network platform 112 of the connection network system 100.

In various embodiments, the connection network system 100 may use the content delivery system 300 to provide a content delivery service via a content delivery application 120 (e.g., software as a service (SaaS)) to its entities 108 (e.g., individuals, members, entities, groups, etc.). The content delivery system 300 is generally designed to deliver electronic content items 134 to entities 108 based, at least in part, on entity data 128 and entity activity data 130 of entities 108 of the connection network system 100. In particular, the content delivery system 300 may deliver content items 134 such as organic content items 314 and/or sponsored content items 316 specifically targeted to an audience of entities 108 based on entity data 128 or entity activity data 130. For instance, a content producer such as an advertiser may create a content delivery campaign 308 such as a marketing campaign or advertising campaign to deliver a series of sponsored content items 316 for a product or service of a business entity to an entity 312 of the connection network system 100 over a defined time interval (e.g., weeks, days, months, etc.). The content producer defines, controls, or manages the content delivery campaign 308 using a set of campaign attributes 310. The campaign attributes 310 may include various objectives of the content delivery campaign 308, such as increasing exposure, revenue, engagement, reach, and so forth.

The content delivery system 300 comprises a set of one or more client devices 104, server devices 102, and data stores 126. A client device 104 and a server device 102 may communicate information via a network 106. The client device 104 may comprise an electronic device, such as a smartwatch, smartphone, tablet, laptop computer, desktop computer, and so forth. The server device 102 may be implemented as a server in a data center, such as a cloud computing system or edge computing system. The client device 104 and the server device 102 may be implemented using an architecture as described in FIG. 17. The network 106 may be implemented using an architecture as described in FIG. 18. Embodiments are not limited to these example implementations.

The server device 102 implements a connection network platform 112 as described with reference to FIG. 1. In one embodiment, the connection network platform 112 includes at least one processor circuitry, at least one memory unit operably coupled to the processor circuitry, the memory unit including instructions executable by the at least one processor circuitry, and an ML model 230 comprising parameters and/or hyperparameters stored in the at least one memory unit. In one embodiment, for example, the ML model 230 is implemented as a two-tower ML model for an AI system implemented by the content delivery system 300 to offer a network service such as a content delivery service by the content delivery application 120 of the connection network platform 112. The content delivery application 120 may select one or more content items 134, such as organic content items 314 and/or organic content items 314, for delivery as targeted content over one or more media channels 304 to a client device 104. A GUI 136 may present the content items 134 in a content feed 138 on the client device 104. An entity 108 from the entity 312 may interact with a GUI element of the GUI 136 to access the targeted content, such as scrolling through the content feed 138 in an X, Y or Z dimension to view the content items 134, clicking on an organic content item 314 or sponsored content item 316 for further inspection, providing feedback using a feedback element 152, and other activities.

The server device 102 may include connection network platform 112 implementing a network service to entity 108 of the connection network platform 112. Professional networking platforms offer a wide range of networking services to facilitate connections, career development, and knowledge sharing. Some examples of a network service offered by the connection network platform 112 include without limitation: (1) users can create a professional profile to showcase their skills, work experience, education, and professional accomplishments; (2) users can connect with colleagues, industry professionals, and potential employers to expand their professional network; (3) messaging capabilities for direct communication between users, facilitating professional conversations and networking opportunities; (4) users can join and participate in industry-specific groups and communities to engage in discussions, share insights, and network with like-minded professionals; (5) search job listings and recruiting tools for users to search for employment opportunities, apply for jobs, and connect with talent; (6) users can share industry-related content, articles, and professional updates to showcase expertise and engage with their network; and (7) access learning resources, courses, and training programs to support ongoing professional development and skill enhancement. These networking services are designed to help professionals connect, collaborate, and grow their careers. Embodiments are not limited to these examples.

In an example process, the connection network platform 112 obtains entity activity data 130 from entities 108 via the client device 104. The entities 108 interact with the connection network platform 112 via a user interface of the connection network platform 112. In some cases, portions of the user interface are displayed on a personal machine or client device 104 of an entity 108. The entity activity data 130 represents various actions, activities or behaviors of one or more entities 108 of the entity 312. For example, entity activity data 130 may represent data collected as the entities 108 interact with various content items 134, such as content items 134, of the data store 126 served via the server device 102. In another example, the entity activity data 130 may represent data collected as the entities 108 interact with other products or services offered by the connection network platform 112, such as searching for job postings, sending messages to entities 108, recommending posts by entities 108, sending and responding to connection requests, playing online games, and other activities organic to use of the connection network platform 112. Session data is any entity activity data 130 collected during a defined session time window, such as activity of the user over a 24 hour period or some other time interval. For example, an entity 108 of the entity 312 may interact with the client device 104 to communicate with the connection network platform 112 of one or more of the server devices 102 to access one or more content items 134 stored by the data store 126. The entities 108 may perform various activities, such as browsing a web site, searching for a job posting, reading content, watching a streaming video, messaging other members, clicking on an GUI item, interacting with an advertisements, or engaging in electronic commerce. The session data, including the entity activity data 130, is transferred between the client device 104 and the server device 102.

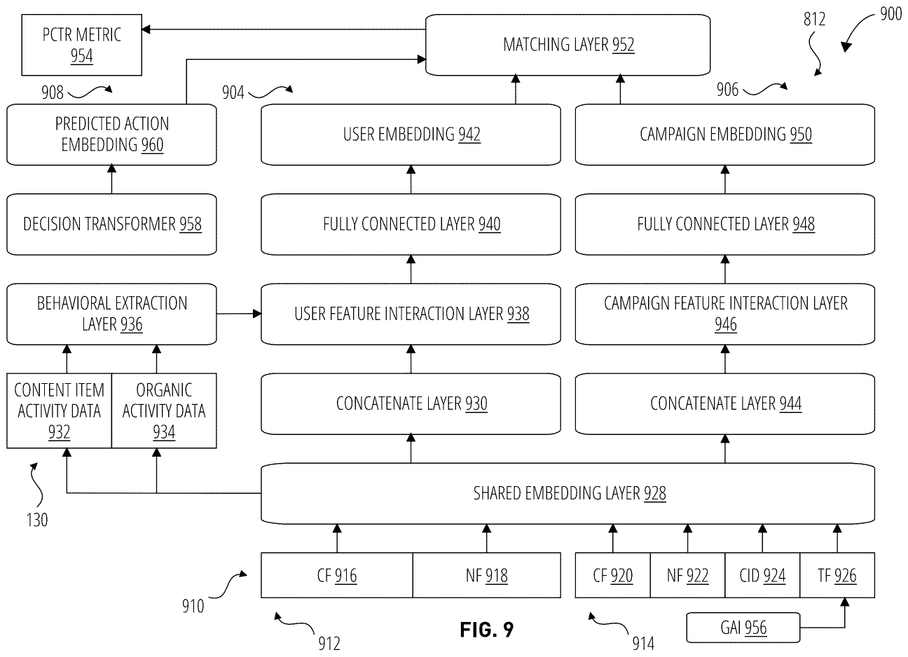

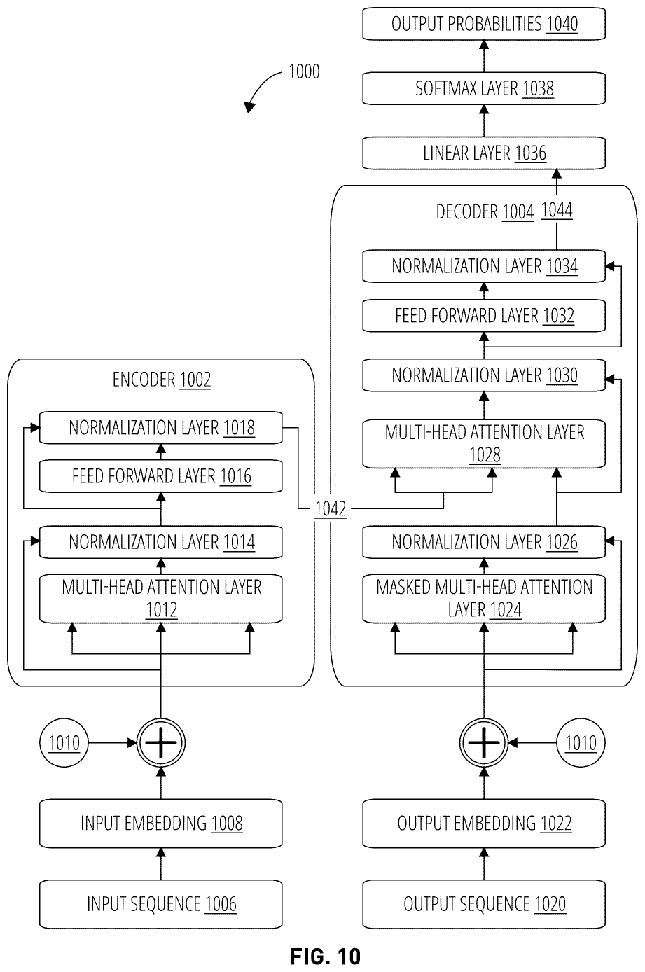

More particularly, the connection network platform 112 comprises the content delivery application 120, which includes or accesses an ML model 230, and data for one or more media channels 304. In particular embodiments, the content delivery system 300 uses multiple ML models 230 to support various downstream tasks for the content delivery application 120. One example of an ML model 230 is a multi-tower ML model to generate a metric for serving advertisements, such as a predicted click-through-rate (pCTR) as described with reference to FIG. 9. Another example of an ML model 230 is a GAI model to generate custom digital content items, such as sponsored content items 316, for the entity 312 as described with reference to FIG. 10. Embodiments are not limited to these examples of ML model 230.

The content delivery application 120 is responsible for delivery of targeted content based on entity activity data 130 and/or session data associated with the entities 108 of the entity 312. The content delivery application 120 uses the multiple ML models 230 to support such activities. The content delivery application 120 then targets delivery of specific content items 134 to users within user segments, such as organic content items 314 and/or sponsored content items 316 for the entity 312, over one or more media channels 304 for presentation on the content feed 138 of the GUI 136. The targeted content is a content item that is relevant to the entity 312 or the entity 312 segment, such as messages, predictions, recommendations, advertisements, or suggestions to improve user experience.

The targeted content is delivered through one or more of the media channels 304. A media channel refers to a specific platform or medium through which targeted content, such as advertisements, are disseminated to a target user. Media channels 304 can include various forms of digital and traditional media such as websites, mobile applications, social media platforms, television, radio, print publications, and outdoor advertising spaces. Each media channel possesses its own unique characteristics and user demographics, allowing advertisers to tailor their messages to reach the desired target user effectively. message provider, such as advertisers, often choose certain media channels based on factors such as user engagement, reach, cost, and the compatibility of the channel with their target market. An example of the media channel 304 is a social media platform or a professional media platform, or some other mode of information transfer within the platform.

The connection network platform 112 or components thereof are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

The data store 126 is an organized collection of data. For example, the data store 126 stores data in a specified format known as a schema. The data store 126 can be structured as a single database, a distributed database, multiple distributed databases, or an emergency backup database. In some cases, a database controller manages data storage and processing in data store 126. In some cases, a user interacts with the database controller. In other cases, the database controller operates automatically without user interaction. The data store 126 is configured to store various content items 134. The content items 134 include any multimedia information suitable for presentation by the client device 104, such as HTML code to present websites, text, images, video, messages, advertisements, and so forth. In addition, the data store 126 may also store application data comprising information and data used by the connection network platform 112. For example, data store 126 is configured to store user session data, profiles, embeddings, budgets, cached application programming interface (API) requests, machine learning model parameters, training data, and other data.

Network 106 facilitates the transfer of information between connection network platform 112, data store 126, and client device 104. Network 106 is a computer network configured to provide on-demand availability of computer system resources, such as data storage and computing power. In some examples, the network 106 provides resources without active management by the entities 108. The network 106 includes data centers available to many users over the Internet. Some large cloud networks have functions distributed over multiple locations from central servers. A server is designated an edge server if it has a direct or close connection to an entities 108. In some cases, a cloud is limited to a single organization. In other examples, the cloud is available to many organizations. In one example, the network 106 includes a multi-layer communications network comprising multiple edge routers and core routers. In another example, the network 106 is based on a local collection of switches in a single physical location.

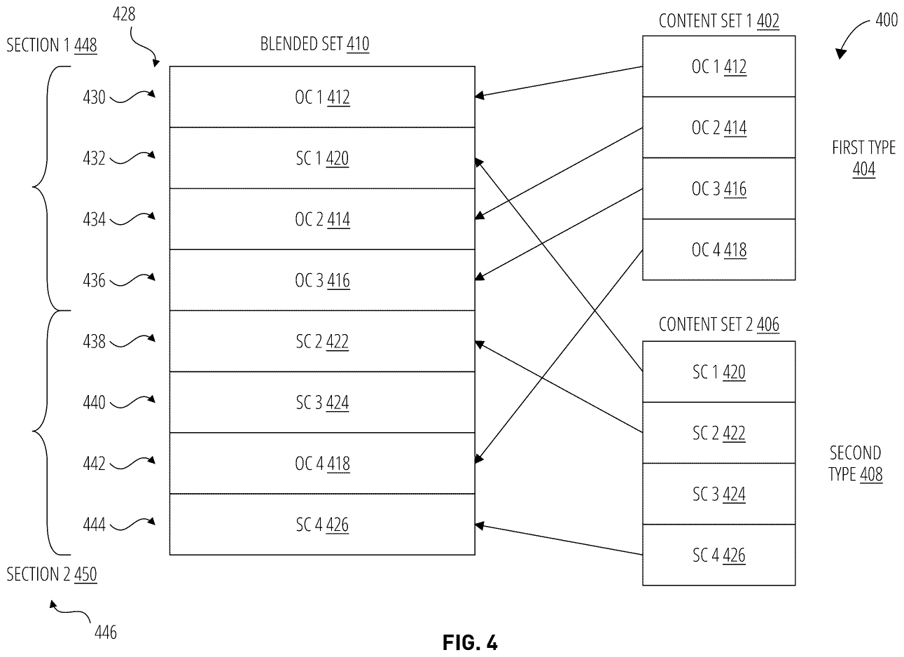

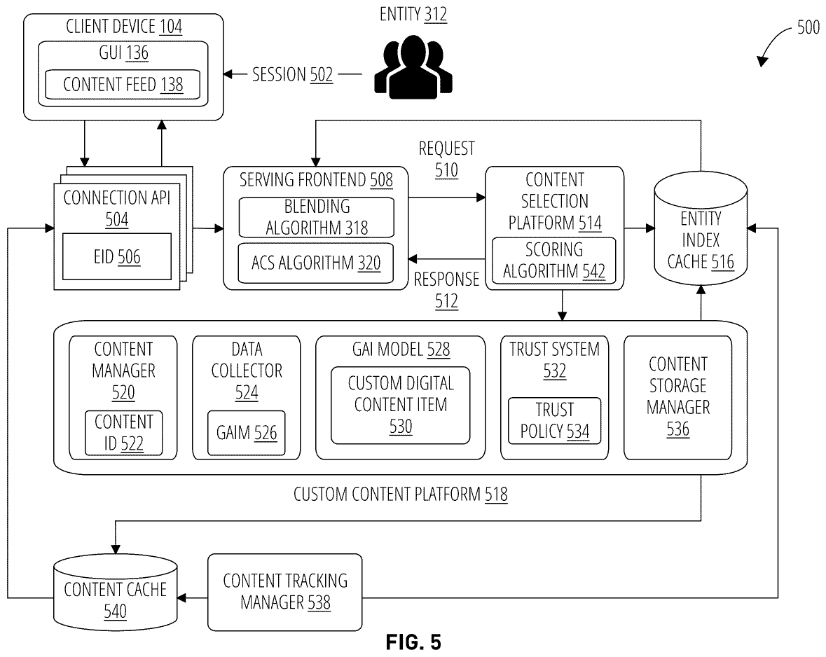

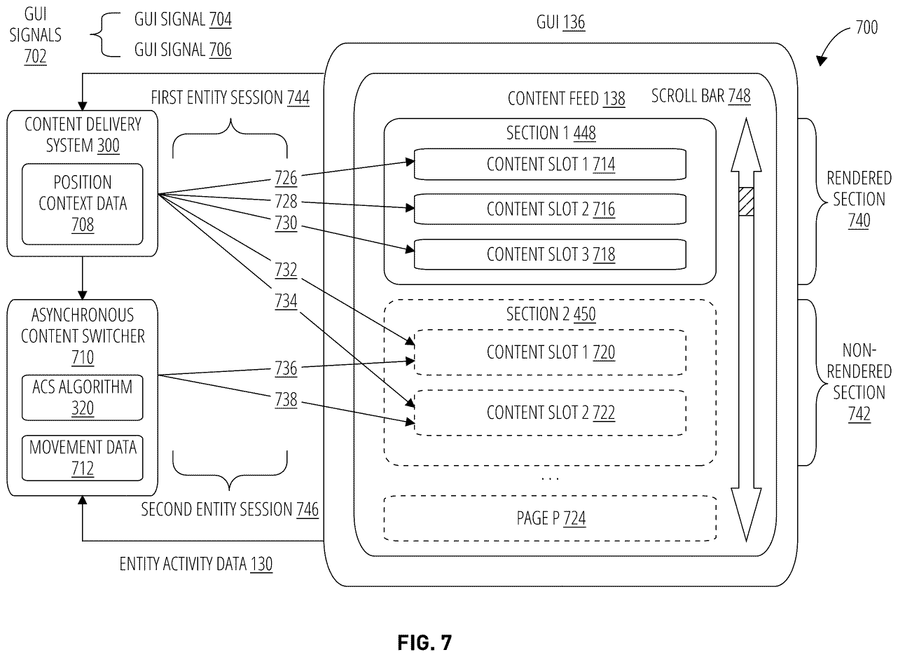

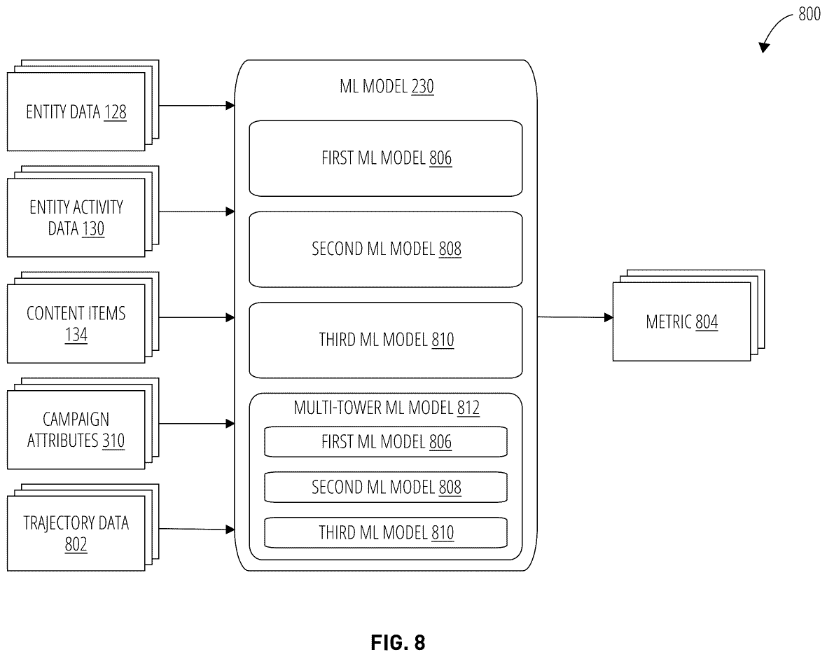

In particular embodiments, the content delivery application 120 uses a combination of ML models 230, a blending algorithm 318, and an ACS algorithm 320 to deliver the content items 134 to the client device 104 of the entity 312. The ML models 230 include a multi-tower model and a GAI model as described with reference to FIG. 8 and FIG. 9, respectively. The blending algorithm 318 blends the organic content items 314 and the sponsored content items 316 for presentation in the content feed 138 of the GUI 136. The blending algorithm 318 is described in more detail with reference to FIG. 4. The ACS algorithm 320 manages timing associated with generating a special form of organic content item 314 comprising a custom digital content item specifically designed for the entity 312. The ACS algorithm 320 is described in more detail with reference to FIG. 5 and FIG. 7.

FIG. 4 illustrates a GUI view 400. The GUI view 400 is an example of a GUI view for the content feed 138 of the GUI 136. Embodiments are not limited to this example.

As depicted in FIG. 4, the GUI view 400 illustrates two types of content items 134. The content set 1 402 comprises content items 134 of a first type 404, such as organic content items 314. The content set 2 406 comprises content items 134 of a second type 408, such as sponsored content items 316. The blending algorithm 318 receives as input the content set 1 402 and the first type 404, and it selects organic content items 314 and sponsored content items 316 from each of the content set 1 402 and content set 2 406, respectively, and allocates each of the content items 134 to a content slot 428 of the content feed 138 to form a blended set 410. The content slots 428 may be for a page 446 of the content feed 138, such as section 1 448 and section 2 450. For example, the blending algorithm 318 may select an OC 1 412 from the content set 1 402 and allocate it to the slot 430, and then select a SC 1 420 from the content set 2 406 for allocation to the slot 432. The blending algorithm 318 continues the selection process by assigning OC 2 414 to slot 434, OC 3 416 to slot 436, SC 2 422 to slot 438, SC 3 424 to slot 440, OC 4 418 to slot 442, and SC 4 426 to slot 444. The blending algorithm 318 makes selections based on a number of factors, such as an entity identifier, entity data 128, entity activity data 130, a ratio of first type 404 to second type 408, historical data, objectives such as optimizing OC revenue and/or SC revenue, engagement metrics, pCTR values, and a host of other factors. Embodiments are not limited to these examples.

The output of the blending algorithm 318 results in a blended set 410 comprising a blend or mix of content items 134 of the first type 404 and the second type 408. The blending algorithm 318 interoperates with the content items 140 to determine which content slots 428 to assign content items 134 and when to assign the content items 134 to different sections, such as rendered sections and non-rendered sections of the content feed 138.

FIG. 5 illustrates a logic diagram 500. The logic diagram 500 is an example of components for a content delivery system 300. Embodiments are not limited to this example.

An entity 302 such as an advertiser accesses a GUI 306 of the content delivery system 300 to create a new content delivery campaign 308 having a set of defined campaign attributes 310 and a set of content items 134 (e.g., digital advertisements) for the content delivery campaign 308. The GUI 306 may include a GUI element (e.g., a checkbox, radio button, text field, etc.) to select creation of a custom digital content item 530 as part of the set of content items 134 for the content delivery campaign 308. The entity 302 may directly access the custom content platform 518 to preview and/or store different custom digital content items 530 for different test entities 312. A trust system 532 may review a base template content item and its associated prompts and basic assets to approve or reject a custom digital content item 530, as described in more detail below. Once the trust system 532 and/or the entity 302 approves a give custom digital content item 530, the custom digital content item 530 is added to the entity index cache 516, as described in more detail below.

As depicted in FIG. 5, the logic diagram 500 shows an entity 312 such as a user (e.g., a member) accessing a GUI 136 presented on a client device 104 to start a session 502 between the client device 104 and the connection network platform 112 of the connection network system 100 via a connection API 504. The connection API 504 is a call to begin loading one or more pages 446 of the content feed 138 of the GUI 136 with the serving frontend 508. The connection API 504 retrieves an entity ID 506 for the entity 312 along with session data for the session 502.

The serving frontend 508 receives the entity ID 506 for the session 502. The serving frontend 508 is responsible for serving content items 134 in real-time or near real-time to the content feed 138 of the GUI 136. The serving frontend 508 implements the blending algorithm 318 to blend content items 134 of the first type 404 and the second type 408, such as organic content items 314 and sponsored content items 316, for example. The serving frontend 508 sends a request 510 for content items 134 for the content feed 138 to the content selection platform 514. The serving frontend 508 receives a response 512 from the content selection platform 514 with the content items 134.

The content selection platform 514 is responsible for retrieving the content items 134 from a data store such as an entity index cache 516, which stores content items 134 of the first type 404 and the second type 408 indexed for fast retrieval. An index service indexes the content items 134 for the entity index cache 516. A content selection platform 514 implements a content serving flow service that matches content items 134 for a content delivery campaign 308 with the entity 312 associated with an entity ID 506. The content serving flow service performs the matching using the campaign attributes 310. In parallel, the content service flow service reads data from the entity index cache 516 for any custom digital content item 530 that is ready to serve to the entity ID 506 (e.g., a flag is set). The entity index cache 516 may be indexed using a key-value pair, where the key is an entity ID 506, the value represents a list of sponsored content items 316 and custom digital content items 530 generated within a defined time period (e.g., days, weeks, months, etc.). The entity index cache 516 may also include additional data, including associated embedding data and labeled data. The content items 134 may comprise content items 134 generated before the start of the session 502. The content items 134 may also comprise content items 134 generated after the start of the session 502. The content items 134 may further comprise custom digital content item 530 generated by the custom content platform 518 for the entity ID 506 associated with the entity 312. The content selection platform 514 selects and retrieves the content items 134 relevant to the entity 312 using the entity ID 506 from the entity index cache 516. The content selection platform 514 sends the content items 134 to the serving frontend 508 via the response 512.

The content selection platform 514 computes a delta value between a set of total custom digital content items 530 for a content delivery campaign 308 versus a first subset of custom digital content items 530 ready for service (“ready items”) to obtain a second subset of custom digital content items 530 that are not ready for service (“not-ready items”). The second subset of not-ready items are those custom digital content items 530 that have not been created yet or have not been added to the entity index cache 516. The content selection platform 514 removes the second subset of not-ready items from consideration for service but maintains the not-ready items in a scoring list for scoring purposes to support cost-to-serve optimizations. The content selection platform 514 may implement trigger logic for the cost-to-serve optimizations.

The content selection platform 514 may include various additional components to assist in the serving process, such as an index matching component for indices used by the entity index cache 516, a pacing component for timing, a filter to filter out previously viewed content items 134 (e.g., deduplication of identical or similar content items 134), a post-filter component to recheck output of the filter, and an auction system for allowing entities 302 to engage in bidding operations for sponsored content items 316. In some embodiments, the content selection platform 514 includes a scoring algorithm 542 to score the custom digital content items 530 using GAI metadata. For example, the scoring algorithm 542 may generate a predicted click-through-rate (pCTR) score and/or an effective cost per mile (eCPM) score. The GAI metadata helps differentiate a pCTR for a custom digital content item 530 and a pCTR for other types of content items 134. In some cases, the pCTR for a custom digital content item 530 may have a weighted coefficient to promote the custom digital content item 530 over other types of content items 134. The weighted coefficient may be one of the campaign attributes 310 that can be set by the entity 302. In some cases, the scoring algorithm 542 may use the GAI metadata as an additional signal to for a new model optimized for custom digital content items 530 (e.g., a pXTR model).

Once the scoring algorithm 542 generates scores (e.g., pCTR and/or eCPM scores), the content selection platform 514 may implement a shadow auction system to determine whether a not-ready item would be selected for a next content slot 428 in the content feed 138. If so, the content selection platform 514 may call the custom content platform 518 to generate a custom digital content item 530. If not, the content selection platform 514 may wait until the not-ready item will be selected for the next content slot 428 in the content feed 138 before calling the custom content platform 518 to generate a custom digital content item 530. This algorithm controls efficiency for the content selection platform 514 and the custom content platform 518. For example, assume the entity 312 visits the connection network platform 112 once a week, there are 5000 custom digital content items 530 in demand (e.g., not-ready items), and the entity 312 only views 1 custom digital content item 530 per week. Without optimizations, generating 5000 custom digital content items 530 at $0.02 per generation results in a generation cost of $100. The entity 312 will view only 1 custom digital content item 530 and 4999 custom digital content items 530 are wasted. With optimizations, the custom content platform 518 only generates a custom digital content item 530 when a not-ready item wins the shadow auction, which lowers the generation cost to $0.02 since only a single custom digital content item 530 was generated. In some cases, a number of custom digital content items 530 may be pre-generated for the entity 312 and stored in the entity index cache 516 as a trade-off between latency (e.g., serving time) and generation cost.

When the content selection platform 514 receives the request 510 indicating the start of the session 502, the content selection platform 514 may call or send an instruction to the custom content platform 518 to start generation of a custom digital content item 530 for the entity 312 using the entity ID 506. The custom content platform 518 receives the instruction and the entity ID 506, and it begins generation of the custom digital content item 530.

The custom content platform 518 is responsible for generating a custom digital content item 530 for the entity ID 506. A content manager 520 operates as an endpoint (e.g., d2://gaiAd), with an action “create,” which accepts the entity ID 506, a content ID 522, and some additional fields such as eCPM, organic content item 314 next to the content slot 428, and other data that may assist with better content generation. A data collector 524 retrieves GAI metadata 526, such as entity data 128, entity activity data 130, previous custom digital content items 530 generated for the entity 312, campaign attributes 310, entity preferences, trust preferences, and so forth. The data collector 524 provides GAI metadata 526 to the GAI model 528.

The GAI model 528 generates the custom digital content item 530 based on entity ID 506, the content ID 522, and the GAI metadata 526. Generative AI models leverages advanced neural network architectures, such as a transformer, to produce contextually coherent text (or other data modalities). The GAI model 528 may be implemented using a number of GAI models. For example, the GAI model 528 may be implemented as a Generative Pre-trained Transformer (GPT) which uses large-scale, unsupervised pre-training via a causal language modeling objective for predicting a next token from a unidirectional context. This approach enables GPT to learn nuanced language patterns, making it effective in tasks like text generation and summarization. Bidirectional Encoder Representations from Transformers (BERT), though not generative in its native form, trains on a masked language modeling objective in a bidirectional context. The learned representations from BERT is the basis for generative variants, such as Bidirectional and Auto-Regressive Transformers (BART), which use BERT-like encoders alongside GPT-like decoders, and Text-to-Text Transfer Transformer (T5), which is a “text-to-text” framework that uniformly casts diverse NLP tasks (summarization, translation, question-answering) into a single text generation paradigm.

In some embodiments, the GAI model 528 comprises a Retrieval-Augmented Generation (RAG) model. RAG extends transformer-based generative modeling by integrating an external retrieval component. A retrieval model, such as a Dense Passage Retrieval (DPR) or a term-based solution like BM25, selects relevant context from a large external knowledge base. The retrieved context then feeds into a sequence-to-sequence generator (like T5 or BART), grounding the output in factual evidence rather than solely relying on the model's internal parameters. This fusion of retrieval and generation not only reduces hallucination but also improves interpretability by making the evidence chain explicit.

A trust system 532 receives the custom digital content item 530 and reviews the custom digital content item 530 to ensure compliance with one or more trust policies 534. The trust system 532 comprises a multilayer validation pipeline, starting with syntactic and semantic checks to flag disallowed or anomalous content. The trust system 532 may use a secondary classifier that is trained on an annotated dataset of malicious, biased, or factually incorrect outputs. The secondary classifier assigns confidence scores to each generated passage. The trust system 532 may use embedding-based similarity checks (e.g., cosine similarity with known “safe” embeddings) to filter out-of-scope or harmful content. Combined with more traditional rule-based filters (e.g., regex or keyword checks for hateful language), these classifiers create the first line of defense. As a second step, the pipeline can pass potentially risky outputs to a knowledge retrieval component (e.g., like BM25 or Dense Passage Retrieval) to verify factual consistency against an up-to-date corpus or knowledge base, generating a final factual-consistency score. For deeper trust analyses, more advanced techniques such as natural language inference (NLI) models can measure the logical coherence of the generated text relative to recognized facts. Reinforcement learning or model-based calibration may be implemented, where the GAI model 528 is iteratively refined via reward signals linked to correctness and user feedback. Confidence calibration, such as temperature scaling or Platt scaling, ensures that the probability estimates generated by the trust system 532 remains well-aligned with real-world likelihoods of correctness. Logging all decisions and confidence metrics enables explainability and debugging, allowing tracing of how each piece of generated text was scored and adjudicated. Once the trust system 532 verifies the custom digital content item 530, the trust system 532 marks the custom digital content item 530 as ready.

A content storage manager 536 writes the custom digital content item 530 into the entity index cache 516 and a content cache 540. The content storage manager 536 custom digital content item 530 writes the custom digital content item 530 to the content cache 540 using a key-value pair, where the key is the content ID 522 and the value is the custom digital content item 530. The content storage manager 536 may also write additional metadata for the custom digital content item 530 to the content cache 540, such as a time-to-live (TTL) parameter. The content storage manager 536 appends the content ID 522, the custom digital content item 530, and additional metadata (e.g., TTL) into the content cache 540. The content storage manager 536 also appends the content ID 522, the custom digital content item 530 and additional metadata as part of the value of the key-value pair for the entity ID 506 in the entity index cache 516. For scalability, when the entity index cache 516 and/or content cache 540 grows beyond a defined size, garbage collection procedures may remove older custom digital content items 530 or non-performing custom digital content items 530 from the entity index cache 516 and/or content cache 540 to ensure continued scalability of the entity index cache 516 and/or the content cache 540.

The serving frontend 508 receives the selected content items 134 from the content selection platform 514. The blending algorithm 318 receives the content items 134 as a first input, and it performs blending operations to blend the organic content items 314 and the sponsored content items 316 into one or more pages 446 for the content feed 138. The ACS algorithm 320 manages timing operations for the blending algorithm 318. The ACS algorithm 320 sends timing signals to the blending algorithm 318. The blending algorithm 318 uses the timing signals as a second input, and it allocates the content items 134 to a page 446 of the content feed 138, such as section 1 448 and section 2 450, based on the timing signals from the ACS algorithm 320.

Once the custom digital content item 530 is added to the content feed 138, a content tracking manager 538 tracks feedback information from a feedback element 152 associated with the custom digital content item 530. The feedback information may include implicit or explicit feedback from the entity 312. Implicit feedback may include views, impressions, session time, and other types of information. Explicit feedback may include clicks, likes, dislikes, shares, and other types of information. The implicit feedback and explicit feedback is logged in the content cache 540 as additional metadata for the custom digital content item 530. The feedback information may be used to improve the content service, selection service, ranking service, generation service, trust service, storage service, and other services associated with the logic diagram 500. For example, the content tracking manager 538 may remove a custom digital content item 530 from the entity index cache 516 if the entity 312 has already viewed the custom digital content item 530, thereby forcing the content selection platform 514 to call the custom content platform 518 to generate a new custom digital content item 530 for the entity 312.

Once serving frontend 508 returns a set of content items 134 for the content feed 138 via the connection API 504. The set of content items 134 comprise different types, such as an organic content items 314 of the first type 404 and a sponsored content items 316 of the second type 408. The GUI 136 renders a first content item in a rendered section of the GUI (e.g., rendered to the entity 312). The rest of the set of content items 134 are not immediately rendered, and instead stored inside a cache for the content feed 138 using a pagination technique. When the entity 312 navigates the GUI 136 using a GUI element from a rendered area of the GUI 136 to a non-rendered area of the GUI 136 thereby making the non-rendered area now rendered, the GUI 136 renders the stored content items 134 in the rendered area. In real-time or near real-time, the ACS algorithm 320 performs a switch when pagination happens, replacing a previously rendered content item with a new content item. In some cases, during navigation, a custom digital content item 530 may transition from not ready to a ready state. In this case, this is an additional trigger to perform real-time auction checking during the pagination process. When the serving frontend 508 is ready to serve the custom digital content item 530, it will send the custom digital content item 530 and content ID 522 to a rendering algorithm. The rendering algorithm will check to see if the content ID 522 indicates a custom digital content item 530. If so, it will indicate this in a response via the connection API 504. It will also send any specific formatting flags to change certain properties associated with the custom digital content item 530 (e.g. show “Generated by GAI”). The rendering algorithm will use the content ID 522 to retrieve the GAI generated data from the content cache 540 (e.g., the GAI asset cache). The rendering algorithm will override the GAI generated data with a base UGC (seed) and avoid using snapshot data. The connection API 504 will use the UGC data to format the view models to pass to the client application 110. If additional flag behavior is needed (e.g. “generated by GAI” flag), the formatters are modified to handle this behavior accordingly. The client application 110 will render the content items 134 with existing GUI templates for new GAI formats.

The content delivery system 300 uses the architecture or framework provided by the example logic diagram 500 to implement a number of techniques to increase serving efficiency of custom digital content items 530. The GAI model 528 consumes a significant amount of technical resources (e.g., compute, memory, bandwidth, power, etc.) to generate each custom digital content item 530. As such, the logic diagram 500 is designed to efficiently expend resources. The logic diagram 500 implements techniques that optimize efficient generation and serving of custom digital content items 530.

In some embodiments, for example, the content delivery system 300 implements a shadow auction technique as previously described. Given advertiser bidding, and market dynamics, there could be many advertisers competing, thus GAI serving will only trigger GAI generation when a custom digital content item 530 outperforms all the other content items 134. Thus, the content selection platform 514 pre-scores and pre-auctions a not-ready custom digital content item 530 then decides whether to actually generate (or not) the custom digital content item 530. The content selection platform 514 uses the scoring algorithm 542 for a shadow auction for not-ready custom digital content items 530, and collects the pCTR results. The content selection platform 514 performs an auction, and checks a rank of a not-ready custom digital content item 530. If the rank is sufficiently high enough (e.g., first or second ranking) for the next content slot 428 suitable for a sponsored content item 316, it will call the custom content platform 518 for GAI service. The shadow auction technique ensures that whenever the entity 312 scrolls down or re-visits the connection network platform 112 again in a different session 502, the custom digital content item 530 will win over other sponsored content items 316.

In some embodiments, for example, the content delivery system 300 uses a cost-to-serve metric to maximize efficient use of the GAI model 528 as shown in Equation (1) and Equation (2) as follows:

$$GAI Serving Efficiency = 1 - resource waste / total cost - to - serve \qquad EQUATION ( 1 )$$

$$GAI CI Serving Efficiency = impressions / generated \qquad EQUATION ( 2 )$$

In Equation (2), an impression is a number of times a custom digital content item 530 is viewed by an entity 312, and generated is a number of times the custom digital content item 530 is generated for the entity 312. The logic diagram 500 maximizes a rate for serving custom digital content item 530 to reduce the cost-to-serve.

In some embodiments, for example, the content delivery system 300 generates custom digital content items 530 during an active session 502. The content delivery system 300 may support a global online system serving content items 134 to a large set of content feeds 138 (e.g., on the order of millions) for entities 312 around the world at the same time. In some cases, a subset of the content feeds 138 are active feed sessions 502 while another subset of the content feeds 138 are non-active sessions 502. An active feed session 502 is when an entity 312 is navigating (e.g., scrolling) a content feed 138. A non-active feed session 502 is when an entity 312 is not navigating a content feed 138. For example, the entity 312 may switch to another area of the GUI 136 other than the content feed 138, clicking a link, or opening a new tab on the web section. In a non-active feed session 502, the content feed 138 is not generating any impression events. Therefore, the custom content platform 518 only generates custom digital content items 530 when the serving frontend 508 receives a signal from the GUI 136 via the connection API 504 indicating that the entity 312 is engaging in an active feed session 502.

In some embodiments, for example, the content delivery system 300 generates custom digital content items 530 when there is a measurable increase to certain metrics above a defined threshold, such as X % above a pCTR or predicted conversion rate (pCVR). For example, the content selection platform 514 of the content delivery system 300 compares a first pCTR (or eCPM, pCVR, etc.) of a default sponsored content item 316 with a second pCTR of a not-ready custom digital content item 530. The content selection platform 514 will call the custom content platform 518 to generate the custom digital content item 530 when the second pCTR is greater than the first pCTR by X %. Otherwise, the content selection platform 514 will select the default sponsored content item 316 for service to the content feed 138. In this manner, the X % operates as a tuning parameter to dynamically adjust resources allocated to the custom content platform 518.

In some embodiments, for example, the content delivery system 300 generates a custom digital content item 530 that is not shown in a content feed 138 for a given session 502 of an entity 312. In such cases, the custom content platform 518 has already consumed resources in generating the custom digital content item 530. Consequently, the custom content platform 518 stores the custom digital content item 530 in the content cache 540 for serving during a future session 502 with the entity 312 to ensure the consumed resources are not wasted. In some cases, the custom content platform 518 stores the metadata for the custom digital content item 530, such as a priority level, to avoid the custom digital content item 530 from being filtered out by other components of the logic diagram 500, such as pacing random throttle, costs associated with a content delivery campaign 308 (e.g., a maximum amount), ranking algorithms, and so forth. In this manner, certain content slots 428 may be reserved for the custom digital content item 530 to avoid any sunk costs in terms of technical resources.

In some embodiments, for example, the content delivery system 300 generates at a group level rather than individual entities 312. In some cases, a delta between custom digital content items 530 of two members is below a threshold value and contain only a few personalized details (e.g. name, industry, etc.). The content delivery system 300 identifies groupings of related entities 312 or similar entities 312. The content delivery system 300 then implements “templates” for a group of entities 312 rather than for each individual entity 312. This significantly reduces a number of generated templates and allow reuse of an existing template.

In some embodiments, for example, the content delivery system 300 implements a pricing model for generating custom digital content items 530. In some cases, serving may generate a large number of custom digital content items 530 that are not rendered, thereby increasing a cost associated with generating custom digital content items 530 while reducing revenue from entities 302 (e.g., advertisers), as shown in Equation (3):

$$GAI profit = GAI revenue - GAI cost - to - serve \qquad EQUATION ( 3 )$$

To make ensure a larger GAI profit, a floor eCPM (e.g., $0.05) is defined. The custom content platform 518 will only be used to generate a custom digital content item 530 when an eCPM for serving the custom digital content item 530 is greater than the floor eCPM. Other metrics may be used as well, such as ensuring GAI serving efficiency is 0.8 (e.g., 20% is generated but not showed to user), a cost-to-generate is $0.02 (e.g., to generate a GAI content), or a minimal profit margin is at 50% (e.g., from impression revenue. These metrics may impact the pricing model as shown in Equation (4):

$$floor eCPM * ( 1 - Minimal profit margin ) = Cost - to - generate / GAI serving efficiency \qquad EQUATION ( 4 )$$

Given the previous examples, this results in a Floor eCPM=$0.05=(0.02/0.8)/(1−0.5). The pricing model may introduce additional protections as well. For example, given a large budget campaign only and no gaming bid settings (either too low bid or too high bid) and given minimal floor eCPM is 0.05, GAI campaign has to bid $8 per click (e.g., an average pCTR is 0.7%) and $50 for CPM. Auto bidding will follow the manual bidding minimal to enforce eCPM greater than $0.05. GAI generation failures trigger an alert and causes an automatic pause to generating custom digital content items 530. The automatic pause may be enforced by increasing a pass threshold set for the trust system 532. For example, if the trust system 532 normally uses a pass threshold of 90% to verify or pass a custom digital content item 530, the pass threshold may be increased to 95%. This would cause the custom digital content item 530 to fail trust review and be placed in a manual trust queue for review. At least one default custom digital content item 530 among all custom digital content items 530 may be used to ensure the content selection platform 514 earns sufficient revenue from the default custom digital content item 530 to merit generation of the custom digital content items 530. This could be used as a warm-up time (e.g., a cold state, warm state, hot state model). Additional optimizations could be also applied, such as if the custom digital content item 530 is under-delivered, the content selection platform 514 can reduce the margin to improve delivery. If the custom digital content item 530 is well delivered, the content delivery system 300 will only generate and serve the custom digital content item 530 for a given entity 312 when pCTR/pCVR boost is high (e.g., above a defined threshold).

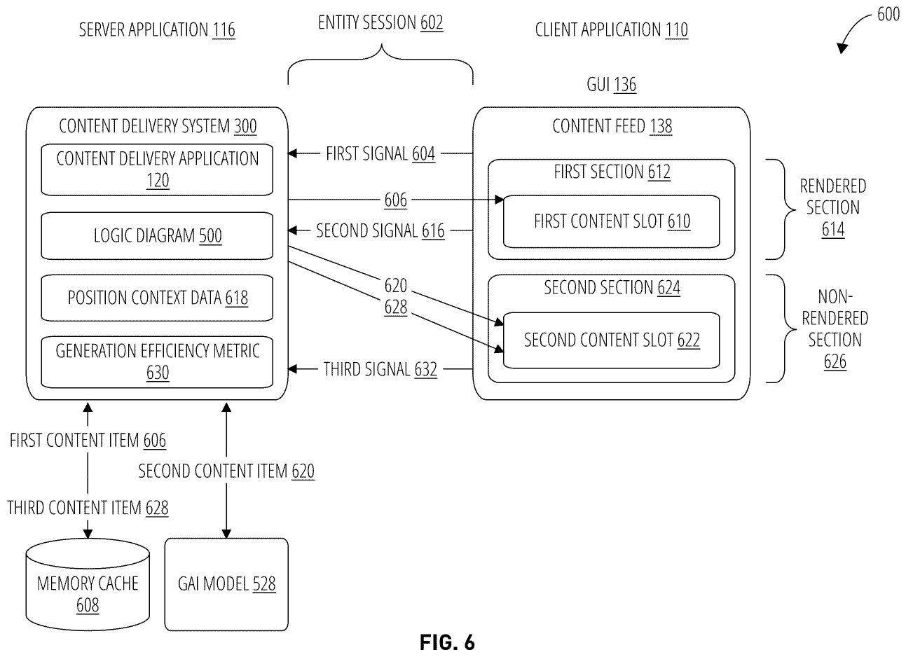

FIG. 6 is a logic diagram 600 of an example architecture for allocating content items 134 in accordance with some embodiments of the disclosure. Specifically, the logic diagram 600 is an example of the content delivery system 300 implementing the logic diagram 500 to allocate content items 134, including organic content items 314 and sponsored content items 316, to a content feed 138 presented on a GUI 136 of a client device 104 associated with an entity 312 as determined using an entity ID 506. In some embodiments, a sponsored content item 316 may comprise a custom digital content item 530 personalized for the entity 312 and generated by the GAI model 528 of the custom content platform 518.

As depicted in FIG. 6, an entity 312 initiates an entity session 602 between a client application 110 of a client device 104 and a content delivery application 120 of a content delivery system 300 of a connection network platform 112 of a connection network system 100. The GUI 136 generates a first signal 604 and sends it to the content delivery system 300. The first signal 604 indicates a start of the entity session 602.

The content delivery system 300 receives the first signal 604 indicating the start of the entity session 602 between the entity 312, via an entity ID 506, and the GUI 136 of the content delivery application 120 of the content delivery system 300. The content delivery system 300 uses the logic diagram 500 to retrieve a first content item 606 associated with the entity ID 506 from a memory cache 608. The first content item 606 may comprise an organic content item 314 or a sponsored content item 316 as selected by the blending algorithm 318. The memory cache 608 may comprise the entity index cache 516 of the logic diagram 500. The content delivery system 300 sends the first content item 606 to the content feed 138 for presentation in a first content slot 610 of a first section 612 of the GUI 136 in response to the first signal 604. The first section is in a rendered section 614 of the GUI 136.

At approximately the same time, the content delivery system 300 calls the GAI model 528 to begin generating a second content item 620 associated with the entity ID 506 in response to the first signal 604. The content delivery system 300 then receives a second signal 616 from the GUI 136 during the entity session 602. The second signal 616 comprises position context data 618 representing a direction of movement from the rendered section 614 to a non-rendered section 626 of the GUI 136. The content delivery system 300 generates the position context data 618, at least in part, from the information provided by the second signal 616 from the GUI 136. The content delivery system 300 assigns a content item to the second content slot 622 of the second section 624 based on when the content delivery system 300 receives the second signal 616 from the GUI 136.

When the content delivery system 300 receives the second signal 616 from the GUI 136 during the entity session 602, the content delivery system 300 determines whether the GAI model 528 has finished generation of the second content item 620. If the GAI model 528 has finished generation of the second content item 620, then the content delivery system 300 assigns the second content item 620 to a second content slot 622 of a second section 624 of the GUI 136 based on the position context data 618. The second section 624 is in the non-rendered section 626 of the GUI 136. If the GAI model 528 has not finished generation of the second content item 620, however, the content delivery system 300 retrieves a third content item 628 from the memory cache 608. The content delivery system 300 assigns the third content item 628 to the second content slot 622 of the second section 624 of the GUI 136.

In some embodiments, for example, the content delivery system 300 does not necessarily need to wait for the second signal 616 before assigning the second content item 620 to the second content slot 622 of the second section 624. As a default action, the content delivery system 300 may assign the second content item 620 to the second content slot 622 of the second section 624 as soon as the GAI model 528 finishes generating the second content item 620 and it is ready to serve. This ensures that the second content slot 622 of the second section 624 has the second content item 620 ready for rendering in the event the entity 312 navigates to the second section 624 faster than expected by the content delivery system 300.

In some embodiments, for example, the content delivery system 300 does not necessarily need to wait for the second signal 616 before assigning the third content item 628 to the second content slot 622 of the second section 624. As a default action, the content delivery system 300 may assign the third content item 628 to the second content slot 622 of the second section 624 when assigning the first content item 606 to the first content slot 610 of the first section 612. This ensures that the second content slot 622 of the second section 624 has the third content item 628 ready for rendering in the event the entity 312 navigates to the second section 624 faster than expected by the content delivery system 300.

In this manner, when the entity 312 navigates from the first section 612 to the second section 624, and the second section 624 is in the rendered section 614 of the content feed 138 of the GUI 136, there is either a second content item 620 or a third content item 628 ready for rendering in the second content slot 622 of the second section 624. This ensures a continuous stream of content items 134 are presented in the content feed 138 without interruption and while avoiding vacant content slots 428.

FIG. 7 is a logic diagram 700 of an example architecture for switching content items 134 in accordance with some embodiments of the present disclosure. Specifically, the logic diagram 700 is a more detailed example of the logic diagram 600.

The logic diagram 700 illustrates the content delivery system 300 implementing an asynchronous content switcher 710 using an ACS algorithm 320 as a component of the content delivery system 300. The ACS algorithm 320 generates timing signals for the blending algorithm 318 to switch content items 134 between pages 446 of a content feed 138 in a way that allows sufficient time for generation of custom digital content item 530 to be allocated to content slots 428 of the content feed 138 in a seamless and continuous manner for presentation to an entity 312. In some embodiments, for example, the blending algorithm 318 and the ACS algorithm 320 may be separate software applications tightly integrated for interoperability, sharing allocation and timing signals. In some embodiments, for example, the blending algorithm 318 and the ACS algorithm 320 are integrated into a single monolithic application. In some embodiments, for example, the content delivery system 300 may implement the asynchronous content switcher 710 as part of (or separate from) the serving frontend 508 as described with reference to FIG. 5.

The logic diagram 700 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the logic diagram 700 is performed by the content delivery system 300 using an asynchronous content switcher 710 implementing the ACS algorithm 320. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

As depicted in FIG. 7, the content delivery system 300 receives a GUI signals 702. The set of GUI signals 702 comprises a first signal such as a GUI signal 704. The GUI signals 702 are from a first entity session 744 between an entity ID 506 and a GUI 136 of a content delivery application 120 of the connection network platform 112 of the connection network system 100. The GUI signal 704 represents a start of the first entity session 744. The content delivery system 300 retrieves a first content item 726 associated with the entity ID 506 from a memory cache, such as entity index cache 516 and/or content cache 540. The first content item 726 may be of a first type 404 or a second type 408. The content delivery system 300 presents the first content item 726 in a first content slot 1 714 of a first section such as section 1 448 of the GUI 136 in response to the first signal. The section 1 448 is in a rendered section 740 of the GUI 136. The content delivery system 300 generates a second content item 736 associated with the entity ID 506 using a GAI model 528 in response to the first signal. The content item 736 is a of the second type 408, such as a sponsored content item 316 like a custom digital content item 530.

The content delivery system 300 receives a second signal from the GUI signals 702, such as a GUI signal 706, from the first entity session 744 representing position context data 708. The position context data 708 comprises context information indicating a position of the section 1 448 and/or the section 2 450 in two-dimension (2D) or three-dimension (3D) cartesian space of the GUI 136. For example, the context information may represent a direction of movement of the scroll bar 748 as the entity 312 navigates between the rendered section 740 and a non-rendered section 742 of the GUI 136. An asynchronous content switcher 710 uses an ACS algorithm 320 to assign the second content item 736 to a second content slot, such as content slot 1 720, of a second section such as section 2 450 of the GUI 136 based on the position context data 708. The section 2 450 is in the non-rendered section 742 of the GUI 136 when the content item 732 is allocated to the content slot 1 720. As the entity 312 uses the scroll bar 748 to navigate from the section 1 448 to the section 2 450, the GUI 136 renders the content item 736 in the rendered section 740 for viewing by the entity 312.

More particularly, the logic diagram 700 illustrates a content delivery system 300 that detects the start of first entity session 744 by, for example, detecting a login or a section load request received from GUI 136. Content delivery system 300 populates a section 1 448 comprising a first group of content slots 428 comprising content slot 1 714, content slot 2 716, and content slot 3 718 of content feed 138 with correspondingly ranked content item 726, content item 728, and content item 730, respectively, at the start of a first entity session 744 between a client device 104 of an entity 312 and the connection network platform 112. The content delivery system 300 further populates a section 2 450 comprising a second group of content slots 428 comprising content slot 1 720 and content slot 2 722 of content feed 138 with correspondingly ranked content item 732 and content item 734, respectively.

In some embodiments, the content item 732 and the content item 734 are of the first type 404 or the second type 408 that are ready for rendering by the GUI 136. Due to the latency associated with generating a custom digital content item 530, the GAI model 528 does not have sufficient time to generate the content item 732 and/or the content item 734 during the first entity session 744. In this case, the content item 732 and/or the content item 734 are generated before the first entity session 744.

The section 1 448 is presented in a rendered section 740 (e.g., rendered) of the content feed 138 that is actually displayed on the GUI 136 for viewing by the entity 312. The section 2 450 is in a non-rendered section 742 (e.g., not rendered or pre-rendered) of the content feed 138 that is not yet displayed on the GUI 136 for viewing by the entity 312 but is prepared for display on the GUI 136 in response to the entity 312 navigating the content feed 138 using the scroll bar 748. For example, the entity 312 may use the scroll bar 748 to scroll in a vertical direction or a horizontal direction thereby activating a pagination mechanism, such as a scroll-to-load mechanism, that renders the section 2 450 in the rendered section 740 of the GUI 136 for viewing by the entity 312.

The number of content slots 428 in each of section 1 448 and section 2 450 is variable and determined based on the requirements of a particular design or implementation of the logic diagram 700. For example, the number of content slots 428 is dependent upon the available screen real estate and/or the size of the available cache on a particular client device 104. In some embodiments, section 2 450 includes the entire remaining portion of the content feed 138 after the rendered section 740, and the blending algorithm 318 employed by content delivery system 300 assigns content items 134 to all of the slots of the entire content feed 138 (e.g., both section 1 448 and section 2 450) at the beginning of the first entity session 744. For example, content delivery system 300 sends all of the content items 134 for the section 1 448 to the client device 104 such that the GUI 136 renders the received content items 134 and stores the content items 134 for the section 2 450 in a server-side cache. This ensures that all of the content slots 428 for all pages 446, rendered or not-rendered, are allocated with content items 134 in the event the entity 312 navigates between pages 446 at a rate that is faster than the GAI model 528 can generate custom digital content item 530.

After the first entity session 744 has started and before the first entity session 744 has ended, for example while the user is scrolling the content feed 138, asynchronous content switcher 710 receives contextual signals such as position context data 708 and entity activity data 130. Asynchronous content switcher 710 receives the contextual signals directly from the GUI 136, via GUI signals 706, or indirectly through an intermediary system such as event logging service like content tracking manager 538. Asynchronous content switcher 710 determines that the first entity session 744 has ended by, for example, detecting a refresh signal received from GUI 136.

The position context data 708 is generated by content delivery system 300 as a result of navigation of the content feed 138 by the entity 312 using the scroll bar 748. An example of position context data 708 is a series of position identifier-content identifier pairs, where the position identifier identifies a slot position, and the content identifier identifies a content item assigned by content delivery system 300 to the slot position identified by the position identifier. The position context data 708 includes additional data in some embodiments. For example, the position context data 708 can include content item metadata such as title, author, publication date, source, or keywords, as well as text, imagery, audio and/or graphics of the content item.

The entity activity data 130 is generated by GUI 136 as a result of interactions with content feed 138 and/or other portions of the GUI 136. Examples of entity activity data 130 include user interactions with one or more of the content item 726, the content item 728, or content item 730 in the content slot 1 714, content slot 2 716, and content slot 3 718, respectively, such as likes, shares, comments, and so forth. The entity activity data 130 is provided to asynchronous content switcher 710 directly from GUI 136 or indirectly through, e.g., the content tracking manager 538. Thus, in some embodiments, the entity activity data 130 includes in-session user interface event data of a single user while in other embodiments, entity activity data 130 includes cross-session user interface event data of the same user and/or one or more other users generated during a second entity session 746.

Asynchronous content switcher 710 incorporates the position context data 708 and entity activity data 130 to infer, predict, or generate movement data associated with the content feed 138. The movement data may include a direction of movement (e.g., up, down, left, right, etc.), a speed of movement (e.g., in milliseconds or microseconds), or a combination of direction and speed (e.g., a vector). The asynchronous content switcher 710 uses the movement data to determine whether the content item 732 and/or content item 734 should remain allocated to the content slot 1 720 and/or the content slot 2 722, respectively, for rendering in the rendered section 740 of the GUI 136. Additionally, or alternatively, the asynchronous content switcher 710 uses the movement data to determine whether a content item 736 and/or content item 738 should replace the content item 732 and/or content item 734 in the content slot 1 720 and/or the content slot 2 722, respectively, for rendering in the rendered section 740 of the GUI 136. In some embodiments, the content item 736 and/or the content item 738 are custom digital content items 530 generated by the GAI model 528. By initially allocating the content item 732 and the content item 734 to the content slot 1 720 and the content slot 2 722, respectively, the content delivery system 300 ensures that the content slot 1 720 and the content slot 2 722 contain content items ready for rendering by the GUI 136. By replacing the content item 732 or the content item 734 in the content slot 1 720 or the content slot 2 722, respectively, the content delivery system 300 ensures that the content slot 1 720 or the content slot 2 722 contain a custom digital content item 530 personalized for the entity 312. In both cases, the entity 312 can navigate the content feed 138 at any rate without a risk of viewing an empty content slot in the rendered section 740 of the GUI 136.

FIG. 8 illustrates a logic diagram 800. The logic diagram 800 is an example of a ML architecture or framework for an ML model 230 suitable for use by the content delivery application 120 of the content delivery system 300. Specifically, the content delivery system 300 may use the logic diagram 800 to generate a set of metrics 804 for an auction system to select a sponsored content item 316 for a next available content slot 428 of the content feed 138. Additionally, or alternatively, the content delivery system 300 may use the logic diagram 800 generate a set of metrics 804 for a shadow auction system to select a custom digital content item 530, such as a not-ready custom digital content item 530, for a next available content slot 428 of the content feed 138.

As depicted in FIG. 8, the logic diagram 800 comprises an ML model 230 receiving various types of input such as entity data 128, entity activity data 130, content items 134, campaign attributes 310, and/or trajectory data 802, either alone or in combination. The ML model 230 analyzes the inputs to recognize patterns, and it generates a metric 804 based on the recognized patterns. The ML model 230 may output at least two types of metrics 804. A first type for the metric 804 may comprise, for example, a value representing an immediate reward such as a predicted click-through-rate (pCTR) metric or universal pCTR metric. A pCTR metric estimates a probability of a user clicking on a content item. The pCTR is useful in selecting a content item for presentation to a user when the outcome is to receive a click or impression for the content item. A second type for the metric 804 may comprise, for example, a value representing a longer term reward, such as a long term pCTR (LT-pCTR) metric. A LT-pCTR metric estimates a next action in a sequence to maximize a given total reward or total return, as defined by a user or a system. The LT-pCTR metric is useful in selecting a content item for presentation to a user when the outcome is to reach a target objective, such as a conversion event for a product or service. The content delivery application 120 may use one or both types of metrics when selecting a next content item to present to a given user for a given marketing campaign.

In some embodiments, the ML model 230 may be implemented as a single ML model, such as a first ML model 806, a second ML model 808, or a third ML model 810. When implemented as a single ML model, the ML model 230 may generate a metric 804.

In some embodiments, the ML model 230 may be implemented as multi-tower ML model 812 comprising multiple ML models. For example, the first ML model 806 is implemented as a first tower, the second ML model 808 is implemented as a second tower, and the third ML model 810 is implemented as a third tower. When implemented as the multi-tower ML model 812, the outputs from all three ML models are combined to generate a metric 804. In some cases, the outputs from all three ML models may be combined using another ML model 230 or a matching layer for an ML model 230.

In some embodiments, the first ML model 806, the second ML model 808, and/or the third ML model 810 may be implemented as a multi-layer perceptron (MLP). A MLP is a fundamental type of artificial neural network (ANN) used in machine learning for supervised learning tasks like classification and regression. It comprises multiple layers of nodes (also called neurons) organized in a sequential structure including an input layer, one or more hidden layers, and an output layer. The input layer receives the initial input data features. The hidden layers perform computations. These layers allow the network to learn complex patterns by introducing non-linear transformations. The output layer produces the final output predictions. Each neuron in one layer is typically connected to every neuron in the next layer through weighted connections, making it a fully connected network. The neurons process inputs by applying a weighted sum followed by an activation function, such as sigmoid, tanh, or Rectified Linear Unit (ReLU), to introduce non-linearity. MLPs are trained using a method called backpropagation, which involves forward propagating inputs to compute outputs, calculating the error between the predicted and actual outputs, and then backward propagating this error to adjust the weights. This process iteratively minimizes the loss function, optimizing the network's performance on the training data. Due to their ability to model complex relationships between inputs and outputs, MLPs are widely used in various applications, including image and speech recognition, natural language processing, and time-series forecasting. They serve as the foundational architecture for more advanced neural networks in deep learning.

In some embodiments, the first ML model 806 is implemented as a MLP designed to receive the entity data 128, the entity activity data 130, and the content items 134 as input. The first ML model 806 retrieves a set of features from the entity data 128, the entity activity data 130, and/or the content items 134, such as member-content item interaction features. The first ML model 806 analyzes the member-content item interaction features for patterns, and it outputs a member embedding.

In some embodiments, the second ML model 808 is implemented as a MLP designed to receive the content items 134 and the campaign attributes 310 as input. The second ML model 808 retrieves a set of features from the content items 134 and the campaign attributes 310, such as campaign-content item features. The second ML model 808 analyzes the campaign-content item features for patterns, and it outputs a campaign embedding.

In some embodiments, the third ML model 810 is implemented as a decision transformer designed to receive the entity data 128, entity activity data 130, the content items 134, and the trajectory data 802 as input. The third ML model 810 retrieves a set of features from the inputs, such as entity trajectory features. The third ML model 810 analyzes the entity trajectory features for patterns, and it outputs a predicted action embedding.

The member embedding, the campaign embedding, and/or the predicted action embedding are input to a matching layer. The matching layer may be implemented as a MLP or a layer of an MLP. The matching layer analyzes the inputs, either alone or in combination, and it generates the metric 804. The metric 804 is fed as an input to the content delivery application 120 for selecting a content item from a set of content items 134, ranking content items 134, recommending content items 134, or performing other network services 156 in support of the connection network platform 112 of the connection network system 100.

FIG. 9 illustrates an ML architecture 900. The ML architecture 900 is an example of a ML architecture or framework suitable for use as ML model 230 for the connection network platform 112 of the content delivery system 300. Specifically, the ML architecture 900 is an example of a ML architecture or framework for a multi-tower ML model 812. The multi-tower ML model 812 may output a metric 804, such as a pCTR and/or a LT-pCTR, suitable for use in various downstream tasks, such as selection of a next content item (e.g., organic content item 314) in a sequence of content items 134, selection of entities 302 for a PA segment of a content delivery campaign 308 suitable for delivery of organic content items 314 to electronic devices of the entities 108 by the content delivery system 300, ranking content items 134, recommending content items 134, and other AI/ML related tasks for the connection network platform 112 of the connection network system 100. In one embodiment, for example, the ML model 230 is an EBR model. Embodiments are not limited to this example.

As depicted in FIG. 9, the ML architecture 900 illustrates an example of a multi-tower ML model 902, such as multi-tower ML model 812 described with reference to FIG. 8, that receives as input an input vector 910, analyzes the input vector 910, and it generates a metric 804 such as a pCTR metric 954. The multi-tower ML model 902 comprises a first tower 904, a second tower 906, and a third tower 908. The first tower 904 is designed to process a first vector 912 of an input vector 910 to generate a user embedding 942. The second tower 906 is designed to process a second vector 914 of the input vector 910 to generate a campaign embedding 950. The third tower 908 is designed to process entity trajectory features for the entities 302 to generate predicted action embeddings. A matching layer 952 generates similarity scores for the user embedding 942, the campaign embedding 950, and the predicted action embedding using a similarity measure, such as cosine similarity. The matching layer 952 ranks and outputs a pCTR metric 954 for an entity 302 based on the similarity measure.

In a particular embodiment, the multi-tower ML model 902 receives an input vector 910 comprising a first vector 912 and a second vector 914 by a multi-tower ML model 902 for a content delivery system 300 of a connection network system 100. The first vector 912 comprises user features representing user attributes and entity activity data 130 associated with entities 108 of the connection network system 100. The second vector 914 comprises campaign features representing a content delivery campaign 308. The campaign features may include, among other campaign features, a textual description of a content delivery campaign 308 managed by the content delivery system 300, denoted as textual features 926 of the second vector 914.

The multi-tower ML model 902 generates multiple embeddings from the input vector 910. The multi-tower ML model 902 generates a set of one or more user embeddings 942 from the first vector 912 by a first tower 904 of the multi-tower ML model 902 based on the entity activity data 130 associated with entities 108 of the connection network system 100. The entity activity data 130 represents content item activity data 932 and organic activity data 934. The multi-tower ML model 902 also generates a set of one or more campaign embeddings 950 from the second vector 914 of the input vector 910 by a second tower 906 of the multi-tower ML model 902 based on, at least in part, the textual description of the content delivery campaign 308. The multi-tower ML model 902 also generates a set of one or more predicted action embeddings from the entity trajectory features. A matching layer 952 of the multi-tower ML model 902 generates a predicted click-through-rate (pCTR) metric, such as pCTR metric 954, based on a subset of the user embeddings 942, a subset of the campaign embeddings 950, and/or a subset of predicted action embeddings.

More particularly, a shared embedding layer 928 of the multi-tower ML model 902 receives as input an input vector 910. An input vector in a machine learning model is a structured array of data that represents a single instance or observation. Each element in this vector corresponds to a particular feature or attribute of the instance, collectively providing a complete description that the model can process. The features can be numerical, categorical (often encoded into numerical form), or even binary, depending on the nature of the data and model requirements. Before being used in the model, these vectors typically undergo preprocessing steps like normalization or encoding to ensure they are in a suitable format. The structure of the input vector must align with what the model expects, as mismatches can lead to errors or suboptimal performance. In practice, multiple input vectors are often processed together in batches for efficiency, especially in models like neural networks. For example, in a model predicting house prices, an input vector might include data such as square footage, the number of bedrooms, and the age of the house, which the model then uses to make its prediction.

The input vector 910 comprises two parts denoted as a first vector 912 and a second vector 914. The first vector 912 comprises data for user-side features (or member-side features) such as categorical features 916 and numerical features 918 representing user-side features for an entity 108, such as entity data 128 and entity activity data 130 for the entity 108. The second vector 914 comprises campaign-side features, such as categorical features 920, numerical features 922, a campaign ID 924, and textual features 926.

In one embodiment, for example, the textual features 926 for the second vector 914 are generated by a separate ML model 230, such as a generative AI (GAI) model denoted as GAI 956. The GAI 956 is designed to create new data samples that resemble a given dataset. Non-limiting examples of GAI 956 include generative adversarial networks (GANs), variational autoencoders (VAEs), transformers in Natural Language Processing (NLP) such as large language models (LLM) like generative pre-trained transformer (GPT) designed to generate human-like text based on a given prompt, diffusion models, autoregressive models, and so forth. In various embodiments, for example, the GAI 956 may be implemented as a transformer model such as a large language model (LLM) like a Bidirectional Encoder Representations from Transformers (BERT) model, Lightweight BERT (LiBERT) model, or a Lightweight Decoding-Enhanced BERT with Disentangled Attention (LiDeBERT) model. The GAI 956 is feed as input information about a content delivery campaign 308, such as one or more campaign attributes 310, and it performs creative content generation with a description for the content delivery campaign 308 in text form. The textual features 926 are derived from the output of the GAI 956.

The input vector 910 is fed into a shared embedding layer 928. An embedding layer in a neural network is a technique used to convert categorical data, such as words or items, into continuous vectors in a lower-dimensional space. This layer is particularly common in natural language processing (NLP) tasks, where it transforms words into dense vectors that capture semantic relationships between them. The embedding layer learns these representations during training, allowing the model to understand and work with complex, high-dimensional categorical data in a more efficient and meaningful way. This approach improves a model's ability to capture similarities and relationships within the data, leading to better performance on tasks like text classification, translation, and sentiment analysis. The shared embedding layer 928 is used in the multi-tower ML model 902 to create a common representation for the first vector 912 and the second vector 914 of the input vector 910 that share similar characteristics, such as words or entities, across different contexts. By using the same embedding layer for multiple inputs, the multi-tower ML model 902 can learn consistent and meaningful representations that capture relationships across the different inputs, regardless of their specific context. This approach is particularly useful in tasks like multi-modal learning or when working with multiple sequences that need to be understood in a unified way, enabling the model to generalize better and reduce the need for redundant parameters.

The first tower 904 receives as input a shared embedding that is output from the shared embedding layer 928. A concatenate layer 930 of the first tower 904 concatenates shared embeddings, and it outputs a concatenated embedding. In addition, the shared embedding is input to a behavioral extraction layer 936. The behavioral extraction layer 936 extracts behavioral pattern features from content item activity data 932 and organic activity data 934 from the shared embedding. The content item activity data 932 represents interactions between an entity identifier for an entity 108 and a content item of the content items 134 from the content delivery campaign 308. Non-limiting examples of content items 134 may comprise organic content items 314 and sponsored content items 316, such as online advertisements from a sequential or non-sequential list of advertisements associated with a content delivery campaign 308. The organic activity data 934 may represent natural activities of an entity 108, such as interactions between an entity 108 and various organic content presented on a website of the connection network platform 112, such as products and/or services offered by the connection network platform 112 of the connection network system 100. Non-limiting examples of organic content include infrastructure elements or supporting elements that enable or support the delivery of content but are not considered content (e.g., backend code, database structures, metadata, etc.), functional elements or structural components that contribute to website functionality or layout (e.g., navigation menus, footers, buttons, sidebars, forms, etc.), GUI elements that include all the interactive and design aspects that help users interact with content items, or user generated content. Non-limiting examples of user generated content may include professional profiles with detailed information about users of the connection network system (e.g., work experience, skills, and endorsements), articles or posts created by users and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where users can share ideas and discuss industry trends, and other types of content designed to facilitate professional growth and industry engagement. Embodiments are not limited to these examples.

The behavioral extraction layer 936 is a specialized component that captures and analyzes user behavior to infer preferences and interests. The behavioral extraction layer 936 uses data from both content item activity data 932 such as advertising activities (e.g., clicks on ads, engagement with promoted content, etc.) and organic activity data 934 such as organic activities of an entity 108 interacting with the connection network platform 112 (e.g., profile views, connections, post interactions, etc.) to build a comprehensive profile of user preferences. The content item activity data 932 includes any interaction an entity 108 has with ads, such as clicks, time spent on ad content, conversions, etc. The organic activity data 934 includes organic activities such as non-ad-based activities like viewing job postings, interacting with professional content, sending messages, making connections, and profile updates. The behavioral extraction layer 936 extracts features from both types of activities, such as frequency of interactions, types of content engaged with, keywords associated with the activities, and behavioral patterns over time. For example, if an entity 108 frequently engages with ads related to data science and also organically interacts with content about AI research, the layer would capture this as a preference for data science and AI. The behavioral extraction layer 936 analyzes these extracted features to infer user preferences or behavior. For instance, it might identify that a user is interested in career development if they engage with content about skill-building and frequently interact with ads promoting courses. This inference could involve techniques like clustering, classification, or neural networks to categorize user preferences. The behavioral preference behavioral extraction layer 936 integrates with the broader recommendation or personalization system within the connection network platform 112. This allows the platform to tailor content, job recommendations, and ads based on the inferred preferences, making the user experience more relevant. In some implementations, the system could incorporate a feedback loop, where the effectiveness of content and ad recommendations is monitored and used to refine the preference extraction process.

For example, assume an entity 108 interacts with connection network platform 112 such as frequently clicking on ads for leadership courses and also engages with content related to team management. The behavioral preference behavioral extraction layer 936 would combine these signals to infer that the entity 108 is interested in leadership development. Consequently, the content delivery system 300 might prioritize showing them related job opportunities, relevant content, and more targeted ads. The behavioral extraction layer 936 helps create a more personalized and relevant user experience by leveraging both advertising and organic activities to understand and predict user preferences more accurately.

A user feature interaction layer 938 receives as input behavioral pattern features from the behavioral extraction layer 936 and the concatenated embedding from the concatenate layer 930. The user feature interaction layer 938 encodes a set of user interaction features based on the behavioral pattern features and the concatenated embedding. The user feature interaction layer 938 is another specialized component that captures and models the interactions between various features related to a user activities, profile attributes, and engagement patterns. The goal of this layer is to better understand how different features or attributes of an entity 108 interact with one another to influence outcomes such as content recommendations, job matches, or social connections. The user feature interaction layer 938 encodes various user-related data points (features) into a format suitable for machine learning. These features could include entity data 128 for an entity 108 such as profile information (e.g., job title, industry, location), entity activity data 130 of the entity 108 (e.g., likes, shares, comments, searches), and network data (e.g., connections, groups). The user feature interaction layer 938 models how different features interact with each other. For example, the user feature interaction layer 938 may determine a relationship between profile and activity interaction, such as a job title for an entity 108 and a type of content items 134 with which the entity 108 interacts. The user feature interaction layer 938 may determine a relationship between network and engagement interaction, such as a size or composition of a user's network impact an entity 108 engagement with content. The user feature interaction layer 938 may determine a relationship between demographics and behavior interaction, such as how do demographic factors like location or industry interact with behavioral data like search history or content sharing. The user feature interaction layer 938 may create cross-feature terms or use advanced techniques like factorization machines or neural networks to capture non-linear interactions between features. Since interactions can exponentially increase the number of features, the user feature interaction layer 938 often includes techniques to reduce dimensionality while preserving important interactions. For example, the user feature interaction layer 938 may implement Principal Component Analysis (PCA) or embedding layers in neural networks.

For example, assume an entity 108 is a software engineer with a history of engaging with AI-related content and is connected to a significant number of AI professionals. The user feature interaction layer 938 would model the interaction between their job title, content engagement, and network connections to better understand their professional focus. This insight could then be used to recommend relevant job postings in AI, suggest connections with key AI influencers, or surface related articles and courses. In this way, the user feature interaction layer 938 enhances the ability to make personalized and relevant predictions by capturing the nuanced relationships between various user attributes and activities.

A fully connected layer 940 receives as input the user interaction features, and it generating the user embedding 942 based on the user interaction features. The fully connected layer 940 generates a user embedding 942 for the set of user embeddings 942 based on the user interaction features identified by the user feature interaction layer 938. The fully connected layer 940 comprises a set of neurons using an activation function, such as a hyperbolic tangent (tanh), for example. More particularly, the fully connected layer 940 in the first tower 904 is a specialized component that connects every neuron from a previous layer to every neuron in a current layer. When used to generate a user embedding 942, this layer takes a high-dimensional input, such as user interaction features describing a user's profile, activity, and preferences, and transforms it into a lower-dimensional vector that encapsulates the user's key characteristics. This embedding serves as a condensed representation of the entity 108, capturing the essential patterns and relationships between different features in a way that the model can use for tasks like recommendations, personalization, or predictions. By learning these embeddings through training, the neural network can effectively encode complex entity data 128 and entity activity data 130 into meaningful and compact vectors that can be leveraged across various applications within the system.

Similar to the first tower 904 of the multi-tower ML model 902, the second tower 906 also includes a concatenate layer 944 and a fully connected layer 948. The concatenate layer 944 and the fully connected layer 948 of the second tower 906 operate in a same or similar manner as described for the concatenate layer 930 and the fully connected layer 940 of the first tower 904. In addition, the second tower 906 comprise a campaign feature interaction layer 946. The user feature interaction layer 938 models user behavioral patterns based on entity data 128 and entity activity data 130, such as content item activity data 932 and organic activity data 934, to infer user interaction features. Similarly, the campaign feature interaction layer 946 models campaign patterns based on campaign attributes 310 and entity activity data 130 representing interactions between entities 108 and content items 134 such as organic content item 314 delivered by a content delivery campaign 308. The concatenate layer 944, the campaign feature interaction layer 946, and the fully connected layer 948 of the second tower 906 represent the processing stages for generating a campaign embedding 950 for a set of campaign embeddings 950 for a given content delivery campaign 308.

A matching layer 952 receives as input the user embedding 942, the campaign embedding 950, and the predicted action embedding from the first tower 904, the second tower 906, and the third tower 908, respectively, and it performs a matching function to match the user embedding 942 and the campaign embedding 950 and the predicted action embedding to determine a pCTR metric 954 for an entity 108. At inference time, matching layer 952 compares the fine-tuned user embedding 942 and the fine-tuned campaign embedding 950 and the fine-tuned predicted action embedding to produce a predicted probability of the corresponding user interacting with the corresponding piece of content. This comparison may, in some example embodiments, involve performing a geometric measurement of the distance between the embeddings in the latent n-dimensional space, such as by using a cosine distance calculation.

The matching layer 952 matches one or more user embeddings 942 with one or more campaign embeddings 950 and/or predicted action embeddings using a similarity measure to form a set of matched embeddings, and it generates a pCTR metric 954 based on the matched embeddings. A matching function in machine learning is designed to compare embeddings, which are compact, vectorized representations of data points, using a similarity measure. The purpose of this function is to assess how closely two embeddings align with one another, typically in tasks like recommendation, search, or classification. Common similarity measures include cosine similarity, Euclidean distance, or dot product, which quantify the degree of resemblance between the vectors. The matching function then uses this measure to determine the best match between embeddings, effectively linking similar items, users, or features based on their underlying patterns as captured by the embeddings. The matching layer 952 uses a similarity measure, such as cosine similarity, to quantify a degree of resemblance between the user embedding 942 of an entity 302, the campaign embedding 950 of a content delivery campaign 308, and the predicted action embedding from the decision transformer. A higher degree of similarity indicates a higher probability that the entity 108 would be interested in organic content items 314 associated with the content delivery campaign 308 and delivered by the content delivery system 300 to obtain a defined outcome, such as a conversion event.

The multi-tower ML model 902 may be trained by a training device on a training dataset of training datapoints. Once trained, the multi-tower ML model 902 may perform inferencing operations on new datapoints to support the content delivery application 120 of the content delivery system 300. In one embodiment, for example, the multi-tower ML model 902 may be trained using a training dataset comprising one or more training datapoints. For example, the training datapoints may comprise pseudo-labels derived from click actions on a web section, such as a landing section, of a GUI 136 of the connection network platform 112 of the connection network system 100. In another example, the training datapoints may comprise chargeable clicks on a web section of a GUI 136 of the connection network platform 112 of the connection network system 100. Embodiments are not limited to these examples. A training device and training operations for the multi-tower ML model 902 are described in more detail with reference to FIG. 13.

FIG. 10 illustrates a transformer model 1000. The transformer model 1000 is an example of a transformer architecture suitable for use by the GAI model 528 of the content delivery system 300. In particular, the transformer model 1000 is an example of a transformer architecture suitable for GPT, such as a version of ChatGPT. ChatGPT is trained on massive amounts of data, allowing it to generate text and respond to various prompts with human-like precision and accuracy. Embodiments are not limited to transformers.

As depicted in FIG. 10, the transformer model 1000 comprises an encoder 1002 and a decoder 1004. The encoder 1002 receives as input an input sequence 1006, which is converted to an input embedding 1008. A positional encoding 1010 is added to the input embedding 1008. The input embedding 1008 with positional encoding 1010 is input to the encoder 1002. The encoder 1002 comprises a multi-head attention layer 1012, a normalization layer 1014, a feed forward layer 1016, and a normalization layer 1018. The encoder 1002 outputs an encoder output 1042 to the decoder 1004. The decoder 1004 receives as input an output sequence 1020, which is converted to an output embedding 1022. A positional encoding 1010 is added to the output embedding 1022. The output embedding 1022 with positional encoding 1010 is input to the decoder 1004. The decoder 1004 comprises a masked multi-head attention layer 1024, a normalization layer 1026, a multi-head attention layer 1028, a normalization layer 1030, a feed forward layer 1032, and a normalization layer 1034.

Specifically, the encoder 1002 is a neural sequence transduction model comprising an encoder 1002 and a decoder 1004. The encoder 1002 receives an input sequence 1006 and it translates the input sequence 1006 into a lower-dimensional space. The encoder 1002 maps an input sequence of symbol representations (x₁, . . . , xₙ) to a sequence of continuous representations z=(z₁, . . . , zₙ). Given z, the decoder 1004 then generates an output sequence (y₁, . . . , yₘ) of symbols one element at a time. At each step, the model is auto-regressive, consuming the previously generated symbols as additional input when generating the next. The decoder 1004 translates the lower-dimensional data provided by the encoder 1002 back to the original data format. Both the encoder 1002 and the decoder 1004 share three main types of layers, including a positional encoding layer, self-attention layer, and feedforward layer.

The encoder 1002 transforms natural language input into numerical vectors. The encoder 1002 receives an input sequence 1006. The input sequence is a sequence of tokens (e.g., words or sub-words) that represent the text input. An input encoding layer of the encoder 1002 converts the input sequence 1006 into an input embedding 1008. An input embedding 1008 is a numerical representation of concepts converted to number sequences. The input embedding 1008 is an NLP technique that represents words with vectors in such a way that once represented in a vectorial space, the mathematical distance between vectors is representative of the similarity among words they represent. For example, the content delivery application 120 may incorporate input embeddings to personalize, recommend, and search content. The input embedding 1008 may comprise a matrix of vectors, where each vector represents a token in the sequence. The input embedding layer maps each token to a high-dimensional vector that captures the semantic meaning of the token.

Positional encoding 1010 is a fixed, learned vector that represents a position of a word in the input sequence. It is added to the input embedding 1008 so that the final representation of a word includes both its meaning and its position. Positional encoding is a technique used in transformer architectures, such as those employed by ChatGPT, to provide information about the relative positions of tokens in the input sequence. Since transformers do not inherently recognize the order of tokens due to their attention mechanism, positional encoding is crucial for enabling the model to consider sequence structure. To capture the order of the tokens in the input sequence, a positional encoding is added to the input embedding 1008. The positional encoding is a vector that represents the position of each token in the sequence.

The encoder 1002 includes multiple self-attention layers. The self-attention layers are responsible for determining the importance of each input token in generating the output. The self-attention layer allows the model to compute relationships between different parts of the input sequence 1006. In order to obtain a self-attention vector for a sentence, the self-attention layer uses query, key, and value matrices. These matrices are used to calculate attention scores between the elements in the input sequence and are three weight matrices that are learned during the training process. In the query, key, and value computations, the input vectors are transformed into three different representations using linear transformations. In an attention computation operation, the model computes a weighted sum of the values, where the weights are based on the similarity between the query and key representations. The weighted sum represents the output of the self-attention mechanism for each position in the sequence.

The encoder 1002 uses a multi-head attention layer 1012. The multi-head attention layer 1012 uses multiple self-attention layers operating in parallel on different parts of the input data, producing multiple representations. The multi-head attention layer 1012 allows the model to focus on different parts of the input sequence and compute relationships between them in parallel. In each head, the query, key, and value computations are performed with different linear transformations, and the outputs are concatenated and transformed into a new representation. The output of the multi-head self-attention mechanism is fed into a feed forward layer 1016.

The feed forward layer 1016 comprises a series of fully connected layers and activation functions. The feed forward layer 1016 transforms the output of the multi-head attention layer 1012 into a suitable representation for the final output. The feed forward layer 1016 is a fully connected layer, also known as a dense layer, where every neuron in the layer is connected to every neuron in the preceding layer. An activation function is a non-linear function that is applied to the output of the fully connected layer. The activation function introduces non-linearity into the output of a neuron, which allows the network to learn complex patterns and relationships in the input data. An example of an activation function is a ReLu. The output of the feed forward layer 1016 is used as input to the next layer in the encoder 1002.

The encoder 1002 may also comprise a number of normalization layers, such as a normalization layer 1014 and a normalization layer 1018. The activations in each layer of the transformer architecture are normalized using layer normalization, which helps stabilize the training process and prevent the model from overfitting. A residual connection followed by layer normalization helps to stabilize the training process and make the model easier to train. The output of the normalization layer 1018 is the final output from the encoder 1002 and it is a vector representation of the input sequence 1006. The final output from the normalization layer 1018 is used as input to the multi-head attention layer 1028 of the decoder 1004.

The decoder 1004 decodes the input sequence 1006 to the original data format. Similar to the encoder 1002, the decoder 1004 shares the core elements of positional encoding, self-attention, and feedforward layers. As depicted in transformer model 1000, the decoder 1004 comprises a masked multi-head attention layer 1024, a normalization layer 1026, a multi-head attention layer 1028, a normalization layer 1030, a feed forward layer 1032, and a normalization layer 1034. The decoder 1004 outputs a decoder output 1044 to a linear layer 1036. The linear layer 1036 is a feedforward network that adapts the dimension of the input to the dimension of the output. The output of the linear layer 1036 feeds into a softmax layer 1038. The softmax layer 1038 transforms the input into a vector of probabilities. The output of the softmax layer 1038 is a set of an output probabilities 1040 for the transformer model 1000. The transformer model 1000 then picks the word corresponding to the highest probability and uses it as a best output of the model.

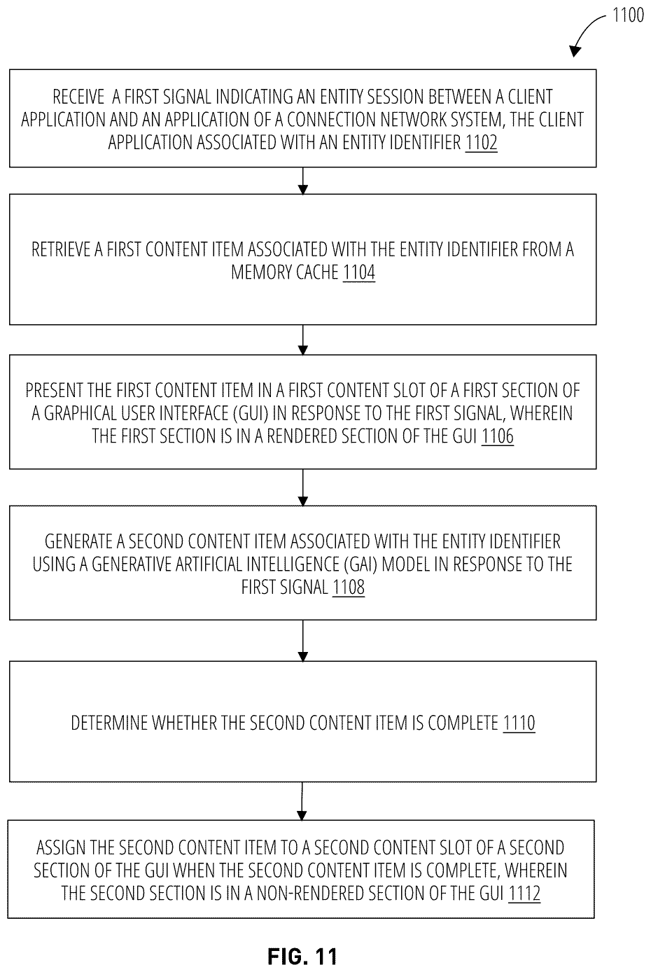

FIG. 11 illustrates an embodiment of a logic flow 1100. The logic flow 1100 may be representative of some or all of the operations executed by one or more embodiments described herein. For example, the logic flow 1100 may include some or all of the operations performed by devices or entities within the connection network platform 112 of the connection network system 100, such as the server device 102 and/or the client device 104. More particularly, the logic flow 1100 illustrates an example of operations for the connection network platform 112 of the connection network system 100, such as the content delivery application 120 for the content delivery system 300. For example, the logic flow 1100 may be performed by the server device 102 and/or the client device 104 using a system 200, content delivery system 300, GUI view 400, logic diagram 500, logic diagram 700, logic diagram 800, ML architecture 900, transformer model 1000, and or apparatus 1300.

As depicted in logic flow 1100, at block 1102, the logic flow 1100 includes receiving a first signal indicating a start of an entity session between a client application and a server application of a connection network system, the client application associated with an entity identifier. At block 1104, the logic flow 1100 includes retrieving a first content item associated with the entity identifier from a memory cache. At block 1106, the logic flow 1100 includes presenting the first content item in a first content slot of a first section of a graphical user interface (GUI) in response to the first signal, wherein the first section is in a rendered section of the GUI. At block 1108, the logic flow 1100 includes generating a second content item associated with the entity identifier using a generative artificial intelligence (GAI) model in response to the first signal. At block 1110, the logic flow 1100 includes determining whether the second content item is complete. At block 1112, the logic flow 1100 includes assigning the second content item to a second content slot of a second section of the GUI when the second content item is complete, wherein the second section is in the non-rendered section of the GUI.

As used herein, the term “complete” refers to a state where a content item is finished and ready to serve in a content slot of a section of the GUI (e.g., such as a content feed). Conversely, the term “incomplete” refers to a state where a content item is still in the midst of generation and is not ready to serve in a content slot of a section of the GUI (e.g., such as a content feed). The content delivery application 120 may implement content monitoring logic to receive measurements from various hardware entities (e.g., sensors, registers, signals, etc.) and software entities (e.g., sub-routines, API calls, code control events, etc.) of the content delivery system 300. The content monitoring logic may receive the measurements and calculate a metric or value to represent whether a content item is in a complete state or an incomplete state. For example, the metric may be binary value (e.g., 0 or 1) or a continuous value (e.g., a percentage of completion from 0% to 100%). Measurement of a complete state or incomplete state of a given content item may be performed using progress bars, callback events, monitoring of GPU usage, a process status indicator, a defined number of steps until a convergence criterion is met, a defined time limit (e.g., a time budget is reached or an internal threshold is met), a loss or noise measurement is below a defined value, progressive versions of different levels of fidelity, an explicit signal, an implicit signal, a synchronous function call, a job status indicator in a job scheduler queue, synchronous signals through returning control to code, asynchronous signals by sending an event or callback signal, log files, and other forms of measurements for a computer. Embodiments are not limited to these examples.

By way of example, with reference to FIG. 6, the logic diagram 600 receives a first signal 604 indicating a start of an entity session 602 between a client application 110 and a server application 116 of a connection network system 100. The client application 110 is associated with an entity ID 506 for an entity 312. The server application 116 may comprise a content delivery application 120 for a content delivery system 300. The content delivery system 300 (or content delivery application 120) retrieves a first content item 606 associated with the entity ID 506 from a memory cache 608. The first content item 726 may be of a first type 404 or a second type 408. The memory cache 608 may comprise an entity index cache 516. The content delivery system 300 presents the first content item 606 in a first content slot 610 of a first section 612 of a GUI 136 in response to the first signal 604. The first section 612 is in a rendered section 614 of the GUI 136. The content delivery system 300 generates a second content item 620 associated with the entity ID 506 using a GAI model 528 in response to the first signal 604. The second content item 620 is of a second type 408, such as a sponsored content item 316 like a custom digital content item 530 for the entity ID 506. The content delivery system 300 determines whether the second content item 620 is complete. The content delivery system 300 assigns the second content item 620 to a second content slot 622 of a second section 624 of the GUI 136 when the second content item 620 is complete. The second section 624 is in the non-rendered section 626 of the GUI 136.

In some embodiments, for example, the content delivery system 300 determines the second content item 620 item is not complete. The content delivery system 300 retrieves and assigns a third content item 628 to the second content slot 622 of the second section 624 of the GUI 136 using the asynchronous content switcher 710.

In some embodiments, for example, the content delivery system 300 receives a second signal 616 sometime during the entity session 602. The second signal 616 comprises position context data 618. The position context data 618 comprises context information indicating a position of first section 612 and/or the second section 624 in two-dimension (2D) or three-dimension (3D) cartesian space of the GUI 136. The position context data 618 may represent movement of the second section 624 from the non-rendered section 626 to the rendered section 614 of the GUI 136. For instance, the position context data 618 may include a direction of movement from the non-rendered section 626 to the rendered section 614 and a speed of movement from the non-rendered section 626 to the rendered section 614. For example, the context information may represent a direction of movement and speed of movement of a scroll bar 748 as the entity 312 navigates between the rendered section 614 and a non-rendered section 626 of the GUI 136.

The content delivery system 300 determines a first time value representing an estimate of when the second content slot 622 of the second section 624 will move to the rendered section 614 of the GUI based on the position context data 618. The content delivery system 300 also determines a second time value representing an estimate of when the second content item 620 will be complete based on a number of factors, such as a type of multimedia content (e.g., text, image, animation, audio, etc.), historical data, type of GAI model 528, and so forth. The content delivery system 300 retrieves and assigns a third content item 628 to the second content slot 622 of the second section 624 of the GUI 136 when the first time value is less than the second time value.

An asynchronous content switcher 710 uses an ACS algorithm 320 to assign the second content item 620 to a second content slot 622 of a second section 624 of the GUI 136 based on the position context data 618. The first section 612 is in the non-rendered section 626 of the GUI 136 when the first content item 606 is allocated to the first content slot 610. As the entity 312 uses the scroll bar 748 to navigate from the first section 612 to the second section 624, the GUI 136 renders the second content item 620 in the rendered section 614 for viewing by the entity 312.

In some embodiments, for example, the content delivery system 300 generates a content ID 522 for the second content item 620, retrieves entity data 128 associated with the entity ID 506, entity activity data 130, campaign data associated with a campaign identifier for a content delivery campaign 308, and a content item template. The content delivery system 300 generates the second content item 620 associated with the entity ID 506 using the GAI model 528 based on the entity data 128, entity activity data 130, campaign data and/or the content item template.

In some embodiments, for example, the content delivery system 300 receives approval of the second content item 620 from a trust system 532 prior to assignment of the second content item 620 to the second content slot 622 of the second section 624. For example, the custom content platform 518 receives approval of the custom digital content item 530 from the trust system 532 prior to assignment of the custom digital content item 530 to the second content slot 622 of the second section 624.

In some embodiments, for example, the content delivery system 300 generates the second content item 620 associated with the entity ID 506 using the GAI model 528 in response to the first signal 604 and a generation efficiency metric 630. The generation efficiency metric 630 may comprise a serving probability value, a session active value, a serving boost value, a serving cost value, or a serving level value. For example, the generation efficiency metric 630 may comprise a cost-to-serve metric, a pCTR or eCPM from a scoring algorithm 542 of a shadow auction system, an active feed signal, a residual signal between a pCTR for a sponsored content item 316 and a custom digital content item 530, a price model signal, a signal for a group of entities 312, a tuning signal, a ready signal, a not-ready signal, a pre-generation signal, and so forth. The content delivery system 300 generates the custom digital content item 530 associated with the entity ID 506 using the GAI model 528 in response to the first signal 604, the generation efficiency metric 630, or a combination of the first signal 604 and the generation efficiency metric 630.

In some embodiments, for example, the generation efficiency metric 630 may comprise a predicted click-through-rate (pCTR) metric such as pCTR metric 954 generated by a multi-tower machine learning (ML) model such as multi-tower ML model 812.

In some embodiments, for example, the content delivery system 300 determines the second content item 620 is not complete during the entity session 602. In this case, the content delivery system 300 assigns the second content item 620 in a content slot 428, such as first content slot 610, of a first section 612 of the GUI 136 in another entity session. The first section 612 is in the rendered section 614 of the GUI 136.

In some embodiments, the content delivery system 300 determines the second content item 620 is not complete during the entity session 602. In this case, the content delivery system 300 stores the second content item 620, a content ID 522 for the second content item 620, and metadata information for the second content item 620, such as GAI metadata 526, in the memory cache 608. The content delivery system 300 receives a third signal 632 indicating a start of another entity session between the client application 110 and the server application 116 of the connection network system 100. The content delivery system 300 assigns the second content item 620 in a content slot 428, such as first content slot 610, of a first section 612 of the GUI 136 in response to the third signal 632. The first section 612 is in the rendered section 614 of the GUI 136.

In some embodiments, for example, the second content item 620 such as the custom digital content item 530 may comprise a set of multimedia information, such as image information, graphic information, animation information, video information, text information, or a combination thereof. Embodiments are not limited to these examples.

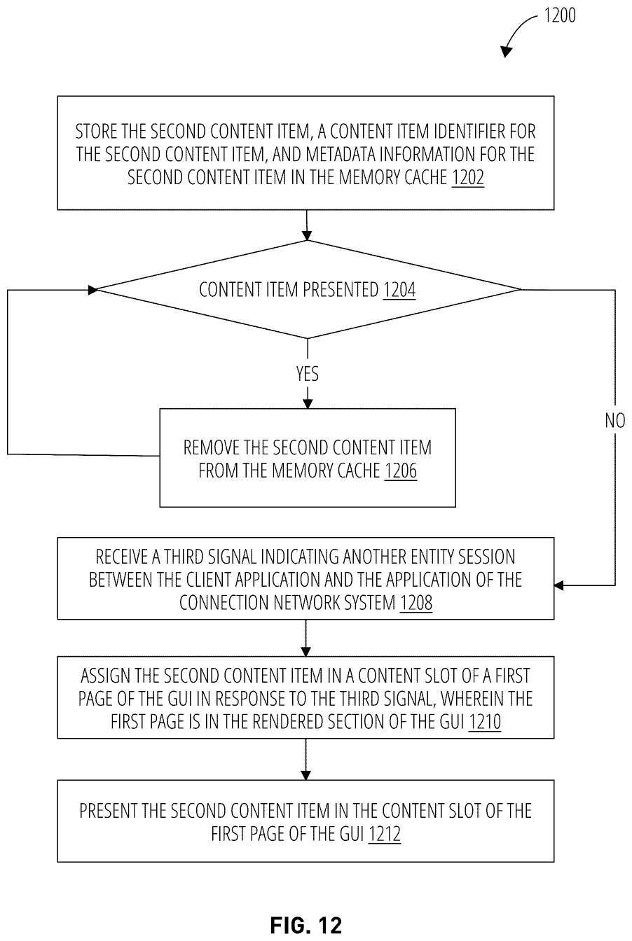

FIG. 12 illustrates an embodiment of a logic flow 1200. The logic flow 1200 may be representative of some or all of the operations executed by one or more embodiments described herein. For example, the logic flow 1200 may include some or all of the operations performed by devices or entities within the connection network platform 112 of the connection network system 100, such as the server device 102 and/or the client device 104. More particularly, the logic flow 1200 illustrates an example of operations for the connection network platform 112 of the connection network system 100, such as the content delivery application 120 for the content delivery system 300. For example, the logic flow 1200 may be performed by the server device 102 and/or the client device 104 using a system 200, content delivery system 300, GUI view 400, logic diagram 500, logic diagram 700, logic diagram 800, ML architecture 900, transformer model 1000, and or apparatus 1300.

As depicted in logic flow 1200, at block 1202 the logic flow 1200 includes storing the second content item, a content identifier for the second content item, and metadata information for the second content item in the memory cache. For example, the content delivery system 300 stores the second content item 620, a content ID 522 for the second content item 620, and metadata information for the second content item 620, such as GAI metadata 526, in the memory cache 608. At decision block 1204, the logic flow 1200 determines whether the second content item has been presented. For example, content delivery system 300 determines whether the second content item 620 has been presented to the entity 312 in the content feed 138.

If YES at decision block 1204, at block 1206, the logic flow 1200 includes removing the second content item from the memory cache. For example, the content delivery system 300 removes the second content item 620 from the memory cache 608 to make room for new custom digital content items 530. The logic flow 1200 returns control to the decision block 1204 for the next content item, such as a new custom digital content item 530.

If NO at decision block 1204, at block 1208, the logic flow 1200 includes receiving a third signal indicating a start of another entity session between the client application and the server application of the connection network system. For example, the content delivery system 300 receives a third signal 632 indicating a start of another entity session between the client application 110 and the server application 116 of the connection network system 100. At block 1210, the logic flow 1200 includes assigning the second content item in a content slot of a first section of the GUI in response to the third signal 632. For example, the content delivery system 300 assigns the second content item 620 in a content slot 428, such as first content slot 610, of a first section 612 of the GUI 136 in response to the third signal 632. At block 1212, the logic flow 1200 presents the second content item in the content slot of the first section of the GUI. For example, the content delivery system 300 presents the second content item 620 in the content slot 428 of the first section 612 of the GUI 136. The first section 612 is in the rendered section 614 of the GUI 136.

FIG. 13 illustrates an apparatus 1300. The apparatus 1300 depicts a training device 1302 suitable for training an ML model 1320 for the connection network system 100, such as the ML models 230 and/or the GAI model 528. Specifically, the training device 1302 trains the ML model 1320 to perform inferencing operations in support of the content delivery application 120 of the content delivery system 300.

As depicted in FIG. 13, the training device 1302 includes a processing circuitry 1304 and a memory unit 1306. The memory unit 1306 may store a set of ML components 1308 to support various AI/ML techniques. The ML components 1308 comprise a data collector 1310, a model trainer 1312, a model evaluator 1314 and a model inferencer 1316.

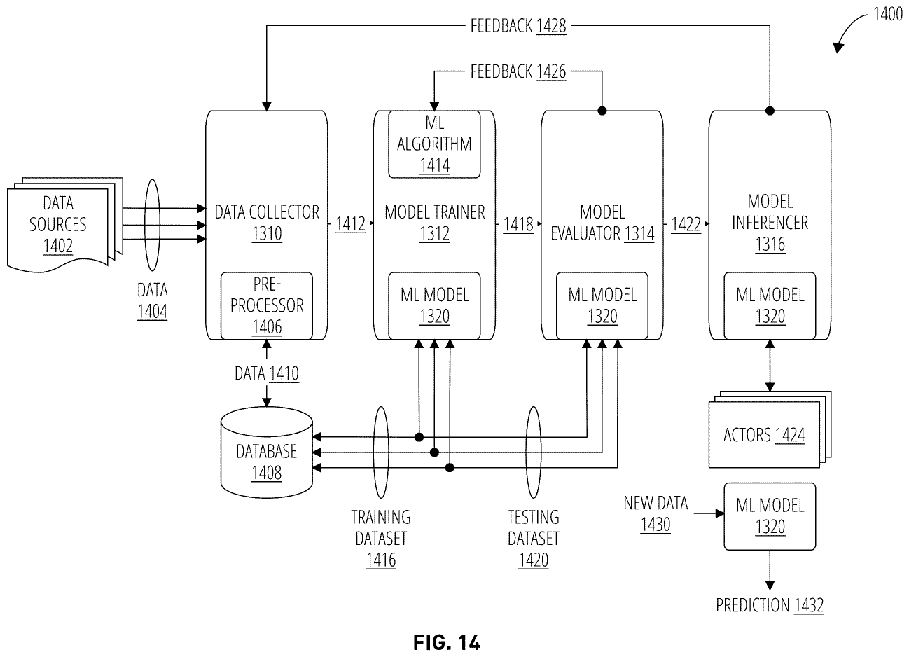

In general, the data collector 1310 collects data 1318 from one or more data sources to use as training data for an ML model 1320. The data collector 1310 collects different types of data 1318, such as text information, audio information, image information, video information, graphic information, and so forth. The model trainer 1312 receives as input the collected data and uses a portion of the collected data as test data for an AI/ML algorithm to train the ML model 1320. The model evaluator 1314 evaluates and improves the trained ML model 1320 using a portion of the collected data as test data to test the ML model 1320. The model evaluator 1314 also uses feedback information from the deployed ML model 1320. The model inferencer 1316 implements the trained ML model 1320 to receive as input new unseen data, generate one or more inferences on the new data, and output a result such as an alert, a recommendation or other post-solution activity. An exemplary AI/ML architecture for the ML components 1308 is described in more detail with reference to FIG. 14.

FIG. 14 illustrates a logic diagram 1400 suitable for use by the training device 1302 to generate the ML model 1320 for deployment by an inferencing device of the connection network platform 112. The logic diagram 1400 is an example of a system suitable for implementing various AI techniques and/or ML techniques to perform various training tasks on behalf of the various devices of the connection network system 100.

In one embodiment, the training device 1302 trains an ML model 1320. In the context of machine learning, “training” refers to the process of teaching a model to recognize patterns and make predictions based on data. This involves initializing the model with initial parameters, which are often set randomly. The model is then provided with a dataset that includes input features and the corresponding correct outputs, often referred to as labels or targets. As the model processes this data, it generates predictions based on its current parameters. The difference between these predictions and the actual target values is measured using a loss function, which quantifies the model's accuracy. The goal is to minimize this loss. To achieve this, the model's parameters are adjusted using optimization techniques such as gradient descent. By continuously refining these parameters, the model gradually improves its predictions. This cycle of making predictions, calculating the loss, and updating parameters is repeated many times, allowing the model to learn and improve over time. The ultimate aim of training is to produce a model that performs well not just on the training data but also on new, unseen data. This ensures the model's ability to generalize, making it effective in real-world applications.

In various embodiments, the training device 1302 may pretrain an ML model 1320 before training the ML model 1320 or trains a pretrained ML model 1320. In the context of machine learning, “pretraining” refers to the initial phase of training a model on a large, general dataset before fine-tuning it on a more specific task or dataset. This approach is particularly common in deep learning, especially with models like neural networks that can benefit from learning basic patterns and representations from broad data before being specialized for a particular application. During pretraining, the model is exposed to a diverse set of data, allowing it to learn fundamental features or representations that are useful across various tasks. For example, in natural language processing, a model might be pretrained on a large corpus of text to understand language structure and grammar. Once the model has acquired this general knowledge, it can be fine-tuned on a smaller, task-specific dataset, such as sentiment analysis or translation. Pretraining is beneficial because it allows the model to start with a good foundation of knowledge, which can lead to better performance and faster convergence during the fine-tuning phase. It also helps when there is limited labeled data for the specific task, as the pretrained model already has a strong understanding from the broader data.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the logic diagram 1400 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1320, evaluate performance of the trained ML model 1320, and deploy the tested ML model 1320 as the trained ML model 1320 in a production environment, and continuously monitor and maintain it.

The ML model 1320 is a mathematical construct used to predict outcomes based on a set of input data. The ML model 1320 is trained using large volumes of training dataset 1416, and it can recognize patterns and trends in the training dataset 1416 to make accurate predictions. The ML model 1320 is derived from an ML algorithm 1414. A data set is fed into the ML algorithm 1414 which trains an ML model 1320 to “learn” a function that produces mappings between a set of inputs and a set of outputs with a reasonably high accuracy. Given a sufficiently large enough set of inputs and outputs, the ML algorithm 1414 finds the function for a given task. This function may even be able to produce the correct output for input that it has not seen during training. A data scientist prepares the mappings, selects and tunes the ML algorithm 1414, and evaluates the resulting model performance. Once the ML model 1320 is sufficiently accurate on test data, it can be deployed for production use.

The ML algorithm 1414 is generally a computational procedure used to identify patterns within data and make inferences or predictions without being explicitly programmed for every scenario. The ML algorithm 1414 can process input data, learn from it by adjusting internal parameters, and then apply the learned information to new, unseen data. The ML algorithm 1414 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1414 of the logic diagram 1400 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naïve Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 14, the logic diagram 1400 includes a set of data sources 1402 to source data 1404 for the training device 1302. Data sources 1402 may comprise any device capable generating, processing, storing or managing data 1404 suitable for a ML system. Examples of data sources 1402 include without limitation databases, web scraping, sensors and Internet of Things (IoT) devices, image and video cameras, audio devices, text generators, publicly available databases, private databases, and many other data sources 1402. The data sources 1402 may be remote from the training device 1302 and accessed via a network, local to the training device 1302 and accessed via a network interface, or may be a combination of local and remote data sources 1402.

The data sources 1402 source difference types of data 1404. By way of example and not limitation, the data 1404 includes structured data from relational databases, such as customer profiles, transaction histories, or product inventories. The data 1404 includes unstructured data from websites such as customer reviews, news articles, social media posts, or product specifications. The data 1404 includes data from temperature sensors, motion detectors, and smart home appliances. The data 1404 includes image data from medical images, security footage, or satellite images. The data 1404 includes audio data from speech recognition, music recognition, or call centers. The data 1404 includes text data from emails, chat logs, customer feedback, news articles or social media posts. The data 1404 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1404 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1402 are communicatively coupled to a data collector 1310. The data collector 1310 gathers relevant data 1404 from the data sources 1402. Once collected, the data collector 1310 may use a pre-processor 1406 to make the data 1404 suitable for analysis. This involves data cleaning, transformation, and feature engineering. Data preprocessing is a critical step in ML as it directly impacts the accuracy and effectiveness of the ML model 1320. The pre-processor 1406 receives the data 1404 as input, processes the data 1404, and outputs pre-processed data 1410 for storage in a database 1408. Examples for the database 1408 includes a hard drive, solid state storage, and/or random access memory (RAM).

The data collector 1310 is communicatively coupled to a model trainer 1312. The model trainer 1312 performs AI/ML model training, validation, and testing which may generate model performance metrics as part of the model testing procedure. The model trainer 1312 receives the pre-processed data 1410 as input 1412 or via the database 1408. The model trainer 1312 implements a suitable ML algorithm 1414 to train an ML model 230 on a set of training dataset 1416 from the pre-processed data 1410. The training process involves feeding the pre-processed data 1410 into the ML algorithm 1414 to produce or optimize an ML model 1320. The training process adjusts its parameters until it achieves an initial level of satisfactory performance.

The model trainer 1312 is communicatively coupled to a model evaluator 1314. After an ML model 1320 is trained, the ML model 1320 needs to be evaluated to assess its performance. This is done using various metrics such as accuracy, precision, recall, and F1 score. The model trainer 1312 outputs the ML model 1320, which is received as input 1412 or from the database 1408. The model evaluator 1314 receives the ML model 230 as input 1418, and it initiates an evaluation process to measure performance of the ML model 1320. The evaluation process includes providing feedback 1426 to the model trainer 1312. The model trainer 1312 re-trains the ML model 1320 to improve performance in an iterative manner.

The model evaluator 1314 is communicatively coupled to a model inferencer 1316. The model inferencer 1316 provides AI/ML model inference output (e.g., inferences, predictions or decisions). Once the ML model 1320 is trained and evaluated, it is deployed in a production environment where it is used to make predictions on new data. The model inferencer 1316 receives the evaluated ML model 1320 as input 1422. The model inferencer 1316 uses the evaluated ML model 1320 to produce insights or predictions on real data, which is deployed as a final production ML model 1320. The inference output of the ML model 1320 is use case specific. The model inferencer 1316 also performs model monitoring and maintenance, which involves continuously monitoring performance of the ML model 1320 in the production environment and making any necessary updates or modifications to maintain its accuracy and effectiveness. The model inferencer 1316 provides feedback 1426 to the data collector 1310 to train or re-train the ML model 1320. The feedback 1426 includes model performance feedback information, which is used for monitoring and improving performance of the ML model 1320.

Some or all of the model inferencer 1316 is implemented by various actors 1424 in the logic diagram 1400, including the ML model 1320 of the connection network platform 112, for example. The actors 1424 use the deployed ML model 1320 on new data to make inferences or predictions for a given task, and output a prediction 1432. The actors 1424 implement the model inferencer 1316 locally, or remotely receives outputs from the model inferencer 1316 in a distributed computing manner. The actors 1424 trigger actions directed to other entities or to itself. The actors 1424 provide feedback 1428 to the data collector 1310 via the model inferencer 1316. The feedback 1428 comprise data needed to derive training data, inference data or to monitor the performance of the ML model 1320 and its impact to the network through updating of key performance indicators (KPIs) and performance counters.

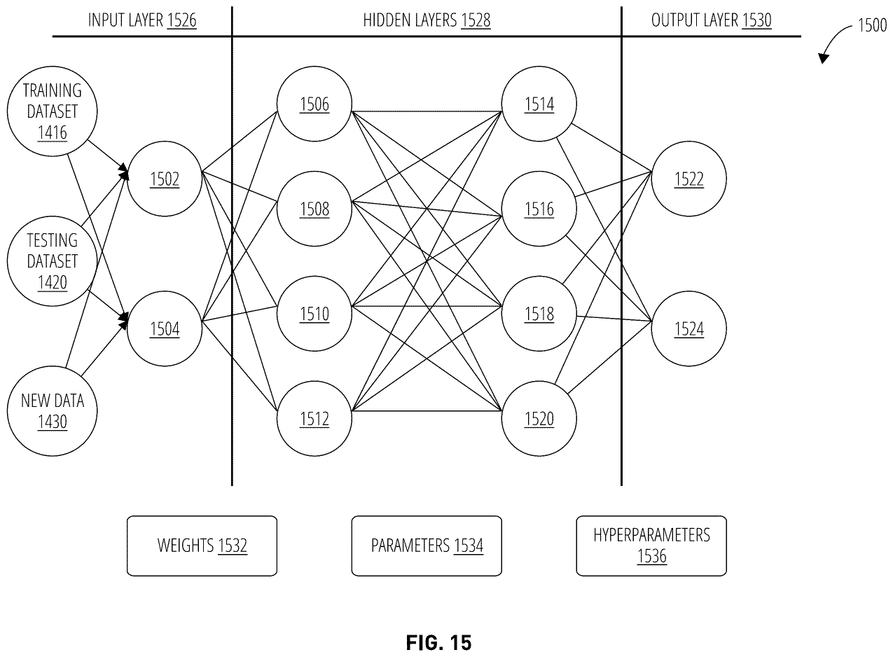

As previously described with reference to FIGS. 1, 2, the connection network system 100 and/or the apparatus 1300 may implement some or all of the logic diagram 1400 to support various use cases and solutions for various AI/ML tasks. In various embodiments, the training device 1302 of the apparatus 1300 uses the logic diagram 1400 to generate and train the ML model 230 for use by the connection network platform 112 for the client application 110. In one embodiment, for example, the training device 1302 may train the ML model 1320 as a neural network, as described in more detail with reference to FIG. 15. Other use cases and solutions for AI/ML are possible as well, and embodiments are not limited in this context.

FIG. 15 illustrates an embodiment of an artificial neural network 1500. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1500 comprises multiple node layers, containing an input layer 1526, one or more hidden layers 1528, and an output layer 1530. Each layer comprises one or more nodes, such as nodes 1502 to 1524. As depicted in FIG. 15, for example, the input layer 1526 has nodes 1502, 1504. The artificial neural network 1500 has two hidden layers 1528, with a first hidden layer having nodes 1506, 1508, 1510 and 1512, and a second hidden layer having nodes 1514, 1516, 1518 and 1520. The artificial neural network 1500 has an output layer 1530 with nodes 1522, 1524. Each node 1502 to 1524 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1500 relies on training dataset 1416 to learn and improve accuracy over time. However, once the artificial neural network 1500 is fine-tuned for accuracy, and tested on testing dataset 1420, the artificial neural network 1500 is ready to classify and cluster new data 1430 at a high velocity. Tasks in speech recognition or image recognition can take minutes versus hours when compared to the manual identification by human experts.

Once an input layer 1526 is determined, a set of weights 1532 are assigned. The weights 1532 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1500 as a feedforward network.

In one embodiment, the artificial neural network 1500 leverages sigmoid neurons, which are distinguished by having values between 0 and 1. Since the artificial neural network 1500 behaves similarly to a decision tree, cascading data from one node to another, having x values between 0 and 1 will reduce the impact of any given change of a single variable on the output of any given node, and subsequently, the output of the artificial neural network 1500.

The artificial neural network 1500 has many practical use cases, like image recognition, speech recognition, text recognition or classification. The artificial neural network 1500 leverages supervised learning, or labeled datasets, to train the algorithm. As the model is trained, its accuracy is measured using a cost (or loss) function. This is also commonly referred to as the mean squared error (MSE). An example of a cost function is shown in Equation (5), as follows:

$$Cost Function = MSE = \frac{1}{2 m} {\sum }_{i = 1}^{m} {( \text{?} - {y}_{i} )}^{2} \to MIN \qquad EQUATION ( 5 )$$

In Equation (5), i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1534 of the model adjust to gradually converge at the minimum.

In one embodiment, the artificial neural network 1500 is feedforward, meaning it flows in one direction only, from input to output. In one embodiment, the artificial neural network 1500 uses backpropagation. Backpropagation is when the artificial neural network 1500 moves in the opposite direction from output to input. Backpropagation allows calculation and attribution of errors associated with each neuron 1502 to 1524, thereby allowing adjustment to fit the parameters 1534 of the ML model 230 appropriately.

The artificial neural network 1500 is implemented as different neural networks depending on a given task. Neural networks are classified into different types, which are used for different purposes. In one embodiment, the artificial neural network 1500 is implemented as a feedforward neural network, or multi-layer perceptrons (MLPs), comprised of an input layer 1526, hidden layers 1528, and an output layer 1530. While these neural networks are also commonly referred to as MLPs, they are actually comprised of sigmoid neurons, not perceptrons, as most real-world problems are nonlinear. Trained data 1404 usually is fed into these models to train them, and they are the foundation for computer vision, natural language processing, and other neural networks. In one embodiment, the artificial neural network 1500 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1500 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1500 is implemented as any type of neural network suitable for a given operational task of system 200, and the MLP, CNN, and RNN are merely a few examples. Embodiments are not limited in this context.

The artificial neural network 1500 includes a set of associated parameters 1534. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1500 is implemented as a deep learning neural network. The term deep learning neural network refers to a depth of layers in a given neural network. A neural network that has more than three layers-which would be inclusive of the inputs and the output—can be considered a deep learning algorithm. A neural network that only has two or three layers, however, may be referred to as a basic neural network. A deep learning neural network may tune and optimize one or more hyperparameters 1536. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

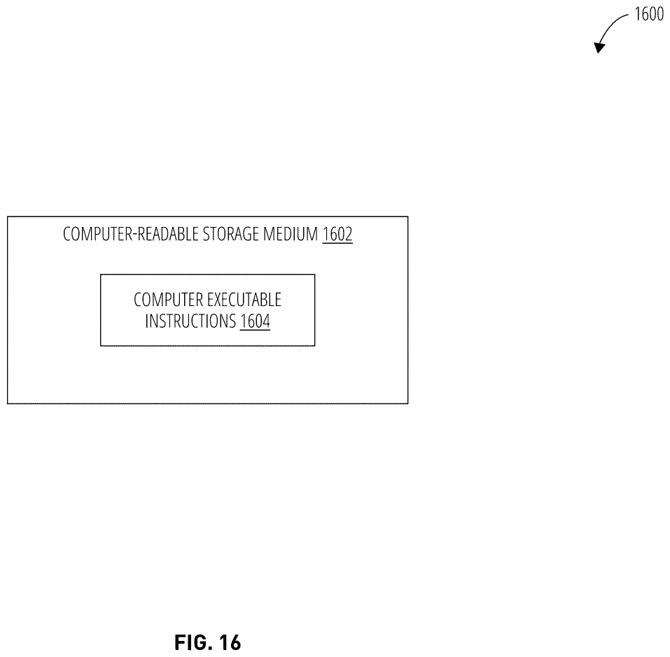

FIG. 16 illustrates an apparatus 1600. Apparatus 1600 comprises any non-transitory computer-readable storage medium 1602 or machine-readable storage medium, such as an optical, magnetic or semiconductor storage medium. In various embodiments, apparatus 1600 comprises an article of manufacture or a product. In some embodiments, the computer-readable storage medium 1602 stores computer executable instructions with which one or more processing devices or processing circuitry can execute. For example, computer executable instructions 1604 includes instructions to implement operations described with respect to any logic flows described herein. Examples of computer-readable storage medium 1602 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1604 include any suitable type of code, such as source code, compiled code, interpreted code, executable code, static code, dynamic code, object-oriented code, visual code, and the like.

FIG. 17 illustrates an embodiment of a computing architecture 1700. Computing architecture 1700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1700 has a single processor with one core or more than one processor. Note that the term “processor” refers to a processor with a single core or a processor package with multiple processor cores. In at least one embodiment, the computing architecture 1700 is representative of the components of the system 200. More generally, the computing architecture 1700 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1700. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the unidirectional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 17, computing architecture 1700 comprises a system-on-chip (SoC) 1702 for mounting platform components. System-on-chip (SoC) 1702 is a point-to-point (P2P) interconnect platform that includes a first processor 1704 and a second processor 1706 coupled via a point-to-point interconnect 1770 such as an Ultra Path Interconnect (UPI). In other embodiments, the computing architecture 1700 is another bus architecture, such as a multi-drop bus. Furthermore, each of processor 1704 and processor 1706 are processor packages with multiple processor cores including core(s) 1708 and core(s) 1710, respectively. While the computing architecture 1700 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1704 and chipset 1732. Some platforms include additional components and some platforms include sockets to mount the processors and/or the chipset. Furthermore, some platforms do not have sockets (e.g. SoC, or the like). Although depicted as a SoC 1702, one or more of the components of the SoC 1702 are included in a single die package, a multi-chip module (MCM), a multi-die package, a chiplet, a bridge, and/or an interposer. Therefore, embodiments are not limited to a SoC.

The processor 1704 and processor 1706 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1704 and/or processor 1706. Additionally, the processor 1704 need not be identical to processor 1706.

Processor 1704 includes an integrated memory controller (IMC) 1720 and point-to-point (P2P) interface 1724 and P2P interface 1728. Similarly, the processor 1706 includes an IMC 1722 as well as P2P interface 1726 and P2P interface 1730. IMC 1720 and IMC 1722 couple the processor 1704 and processor 1706, respectively, to respective memories (e.g., memory 1716 and memory 1718). Memory 1716 and memory 1718 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1716 and the memory 1718 locally attach to the respective processors (i.e., processor 1704 and processor 1706). In other embodiments, the main memory couple with the processors via a bus and shared memory hub. Processor 1704 includes registers 1712 and processor 1706 includes registers 1714.

Computing architecture 1700 includes chipset 1732 coupled to processor 1704 and processor 1706. Furthermore, chipset 1732 are coupled to storage device 1750, for example, via an interface (I/F) 1738. The I/F 1738 may be, for example, a Peripheral Component Interconnect-enhanced (PCIe) interface, a Compute Express Link® (CXL) interface, or a Universal Chiplet Interconnect Express (UCIe) interface. Storage device 1750 stores instructions executable by circuitry of computing architecture 1700 (e.g., processor 1704, processor 1706, GPU 1748, accelerator 1754, vision processing unit 1756, or the like). For example, storage device 1750 can store instructions for the client device 202, the client device 206, the inferencing device 204, the training device 1302, or the like.

Processor 1704 couples to the chipset 1732 via P2P interface 1728 and P2P 1734 while processor 1706 couples to the chipset 1732 via P2P interface 1730 and P2P 1736. Direct media interface (DMI) 1776 and DMI 1778 couple the P2P interface 1728 and the P2P 1734 and the P2P interface 1730 and P2P 1736, respectively. DMI 1776 and DMI 1778 is a high-speed interconnect that facilitates, e.g., eight Giga Transfers per second (GT/s) such as DMI 3.0. In other embodiments, the processor 1704 and processor 1706 interconnect via a bus.

The chipset 1732 comprises a controller hub such as a platform controller hub (PCH). The chipset 1732 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1732 comprises more than one controller hub such as a chipset with a memory controller hub, a graphics controller hub, and an input/output (I/O) controller hub.

In the depicted example, chipset 1732 couples with a trusted platform module (TPM) 1744 and UEFI, BIOS, FLASH circuitry 1746 via I/F 1742. The TPM 1744 is a dedicated microcontroller designed to secure hardware by integrating cryptographic keys into devices. The UEFI, BIOS, FLASH circuitry 1746 may provide pre-boot code. The I/F 1742 may also be coupled to a network interface circuit (NIC) 1780 for connections off-chip.

Furthermore, chipset 1732 includes the I/F 1738 to couple chipset 1732 with a high-performance graphics engine, such as, graphics processing circuitry or a graphics processing unit (GPU) 1748. In other embodiments, the computing architecture 1700 includes a flexible display interface (FDI) (not shown) between the processor 1704 and/or the processor 1706 and the chipset 1732. The FDI interconnects a graphics processor core in one or more of processor 1704 and/or processor 1706 with the chipset 1732.

The computing architecture 1700 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1754 and/or vision processing unit 1756 are coupled to chipset 1732 via I/F 1738. The accelerator 1754 is representative of any type of accelerator device (e.g., a data streaming accelerator, cryptographic accelerator, cryptographic co-processor, an offload engine, etc.). One example of an accelerator 1754 is the Intel® Data Streaming Accelerator (DSA). The accelerator 1754 is a device including circuitry to accelerate copy operations, data encryption, hash value computation, data comparison operations (including comparison of data in memory 1716 and/or memory 1718), and/or data compression. Examples for the accelerator 1754 include a USB device, PCI device, PCIe device, CXL device, UCIe device, and/or an SPI device. The accelerator 1754 also includes circuitry arranged to execute machine learning (ML) related operations (e.g., training, inference, etc.) for ML models. Generally, the accelerator 1754 is specially designed to perform computationally intensive operations, such as hash value computations, comparison operations, cryptographic operations, and/or compression operations, in a manner that is more efficient than when performed by the processor 1704 or processor 1706. Because the load of the computing architecture 1700 includes hash value computations, comparison operations, cryptographic operations, and/or compression operations, the accelerator 1754 greatly increases performance of the computing architecture 1700 for these operations.

The accelerator 1754 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1754. For example, the accelerator 1754 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1754 via a non-posted write (e.g., a deferred memory write (DMWr)). One example of an instruction that atomically submits a work descriptor to the shared work queue of the accelerator 1754 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1754. The dedicated work queue may accept job submissions via commands such as the movdir64b instruction.

Various I/O devices 1760 and display 1752 couple to the bus 1772, along with a bus bridge 1758 which couples the bus 1772 to a second bus 1774 and an I/F 1740 that connects the bus 1772 with the chipset 1732. In one embodiment, the second bus 1774 is a low pin count (LPC) bus. Various input/output (I/O) devices couple to the second bus 1774 including, for example, a keyboard 1762, a mouse 1764 and communication devices 1766.

Furthermore, an audio I/O 1768 couples to second bus 1774. Many of the I/O devices 1760 and communication devices 1766 reside on the system-on-chip (SoC) 1702 while the keyboard 1762 and the mouse 1764 are add-on peripherals. In other embodiments, some or all the I/O devices 1760 and communication devices 1766 are add-on peripherals and do not reside on the system-on-chip (SoC) 1702.

FIG. 18 illustrates a block diagram of an exemplary communications architecture 1800 suitable for implementing various embodiments as previously described. The communications architecture 1800 includes various common communications elements, such as a transmitter, receiver, transceiver, radio, network interface, baseband processor, antenna, amplifiers, filters, power supplies, and so forth. The embodiments, however, are not limited to implementation by the communications architecture 1800.

As shown in FIG. 18, the communications architecture 1800 includes one or more clients 1802 and servers 1804. The clients 1802 and the servers 1804 are operatively connected to one or more respective client data stores 1808 and server data stores 1810 that can be employed to store information local to the respective clients 1802 and servers 1804, such as cookies and/or associated contextual information.

The clients 1802 and the servers 1804 communicate information between each other using a communication framework 1806. The communication framework 1806 implements any well-known communications techniques and protocols. The communication framework 1806 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1806 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1802 and the servers 1804. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

What is claimed is:

1. A method, comprising:
receiving a first signal indicating an entity session between a client application and an application of a connection network system, the client application associated with an entity identifier;
retrieving a first content item associated with the entity identifier from a memory cache;
presenting the first content item in a first content slot of a first section of a graphical user interface (GUI) in response to the first signal, wherein the first section is in a rendered section of the GUI;
generating a second content item associated with the entity identifier using a generative artificial intelligence (GAI) model in response to the first signal;
determining whether the second content item is received; and
assigning the second content item to a second content slot of a second section of the GUI when the second content item is received, wherein the second section is in a non-rendered section of the GUI.

2. The method of claim 1, comprising:
determining the second content item is not received;
retrieving a third content item associated with the entity identifier from the memory cache; and
assigning the third content item to the second content slot of the second section of the GUI.

3. The method of claim 1, comprising:
receiving a second signal during the entity session comprising position context data representing movement of the second section from the non-rendered section to the rendered section of the GUI;
determining a first time value representing an estimate of when the second content slot of the second section will move to the rendered section of the GUI;
determining a second time value representing an estimate of when the second content item will be received; and
assigning a third content item to the second content slot of the second section of the GUI when the first time value is less than the second time value.

4. The method of claim 1, comprising:
generating a content identifier for the second content item;
retrieving entity data associated with the entity identifier, campaign data associated with a campaign identifier, and a content item template; and
generating the second content item associated with the entity identifier using the GAI model based on the entity data, campaign data and the content item template.

5. The method of claim 1, comprising generating the second content item associated with the entity identifier using the GAI model in response to the first signal and a generation efficiency metric.

6. The method of claim 5, wherein the generation efficiency metric comprises a serving probability value, a session active value, a serving boost value, a serving cost value, or a serving level value.

7. The method of claim 5, wherein the generation efficiency metric comprises a predicted click-through-rate (pCTR) metric generated by a multi-tower machine learning (ML) model.

8. The method of claim 1, comprising:
determining the second content item is not received during the entity session; and
assigning the second content item in a content slot of a first section of the GUI in another entity session, wherein the first section is in the rendered section of the GUI.

9. The method of claim 1, comprising:
determining the second content item is not received during the entity session;
storing the second content item, a content identifier for the second content item, and metadata information for the second content item in the memory cache;
receiving a third signal indicating another entity session between the client application and the application of the connection network system; and
assigning the second content item in a content slot of a first section of the GUI in response to the third signal, wherein the first section is in the rendered section of the GUI.

10. A computing apparatus comprising:
circuitry; and
a memory storing instructions that, when executed by the circuitry, causes the circuitry to:
receive a first signal indicating a an entity session between a client application and an application of a connection network system, the client application associated with an entity identifier;
retrieve a first content item associated with the entity identifier from a memory cache;
present the first content item in a first content slot of a first section of a graphical user interface (GUI) in response to the first signal, wherein the first section is in a rendered section of the GUI;
generate a second content item associated with the entity identifier using a generative artificial intelligence (GAI) model in response to the first signal;
determine whether the second content item is received; and
assign the second content item to a second content slot of a second section of the GUI when the second content item is received, wherein the second section is in a non-rendered section of the GUI.

11. The computing apparatus of claim 10, the circuitry to:
determine the second content item is not received;
retrieve a third content item associated with the entity identifier from the memory cache; and
assign the third content item to the second content slot of the second section of the GUI.

12. The computing apparatus of claim 10, the circuitry to:
receive a second signal during the entity session comprising position context data representing movement of the second section from the non-rendered section to the rendered section of the GUI;
determine a first time value representing an estimate of when the second content slot of the second section will move to the rendered section of the GUI;
determine a second time value representing an estimate of when the second content item will be received; and
assign a third content item to the second content slot of the second section of the GUI when the first time value is less than the second time value.

13. The computing apparatus of claim 10, the circuitry to:
generate a content identifier for the second content item;
retrieve entity data associated with the entity identifier, campaign data associated with a campaign identifier, and a content item template; and
generate the second content item associated with the entity identifier using the GAI model based on the entity data, campaign data and the content item template.

14. The computing apparatus of claim 10, the circuitry to generate the second content item associated with the entity identifier using the GAI model in response to the first signal and a generation efficiency metric.

15. The computing apparatus of claim 14, wherein the generation efficiency metric comprises a serving probability value, a session active value, a serving boost value, a serving cost value, or a serving level value.

16. A non-transitory computer-readable storage medium, the computer-readable storage medium including instructions that when executed by circuitry, cause the circuitry to:
receive a first signal indicating an entity session between a client application and an application of a connection network system, the client application associated with an entity identifier;
retrieve a first content item associated with the entity identifier from a memory cache;
present the first content item in a first content slot of a first section of a graphical user interface (GUI) in response to the first signal, wherein the first section is in a rendered section of the GUI;
generate a second content item associated with the entity identifier using a generative artificial intelligence (GAI) model in response to the first signal;
determine whether the second content item is received; and
assign the second content item to a second content slot of a second section of the GUI when the second content item is received, wherein the second section is in a non-rendered section of the GUI.

17. The computer-readable storage medium of claim 16, comprising instructions that when executed by circuitry, cause the circuitry to:
determine the second content item is not received;
retrieve a third content item associated with the entity identifier from the memory cache; and
assign the third content item to the second content slot of the second section of the GUI.

18. The computer-readable storage medium of claim 16, comprising instructions that when executed by circuitry, cause the circuitry to:
receive a second signal during the entity session comprising position context data representing movement of the second section from the non-rendered section to the rendered section of the GUI;
determine a first time value representing an estimate of when the second content slot of the second section will move to the rendered section of the GUI;
determine a second time value representing an estimate of when the second content item will be received; and
assign a third content item to the second content slot of the second section of the GUI when the first time value is less than the second time value.

19. The computer-readable storage medium of claim 16, comprising instructions that when executed by circuitry, cause the circuitry to:
generate a content identifier for the second content item;
retrieve entity data associated with the entity identifier, campaign data associated with a campaign identifier, and a content item template; and
generate the second content item associated with the entity identifier using the GAI model based on the entity data, campaign data and the content item template.

20. The computer-readable storage medium of claim 16, comprising instructions that when executed by circuitry, cause the circuitry to generate the second content item associated with the entity identifier using the GAI model in response to the first signal and a generation efficiency metric.
